(19) United States
(12) Patent Application Publication
(10) Pub. No.: US 2026/0300741 A1
(43) Pub. Date: Oct. 1, 2026

(54) DYNAMIC CONTENT WINDOW BASED ON ENVIRONMENT AND CONTEXT

(71) Applicant: Pansynapse Inc., Orange, CA (US)

(72) Inventors: Pascal Ralph Manfred Simpkins, Costa Mesa, CA (US); Kyle Hendershot, Sherman Oaks, CA (US)

(21) Appl. No.: 19/566,407

(22) Filed: Mar. 13, 2026

Related U.S. Application Data
(63) Continuation-in-part of application No. 19/282,732, filed on Jul. 28, 2025.
(60) Provisional application No. 63/777,214, filed on Mar. 25, 2025.

(51) Int. Cl. G06N 3/0895; G06F 16/901

(52) U.S. Cl. CPC G06N 3/0895; G06F 16/9024

(57) ABSTRACT

A computer system that determines a dynamic content window is described. During operation, the computer system may receive information associated with an environment of an electronic device. Then, the computer system may access a stored context corresponding to the information. Moreover, the computer system may determine a dynamic content window based at least in part on the information and/or the context, where the dynamic content window has a length less than a predefined value. Next, the computer system may generate an input vector based at least in part on the information, the context and the dynamic content window. Furthermore, the computer system may provide, to a pretrained neural network, the input vector and the dynamic content window. Additionally, the computer system may receive, from the pretrained neural network, a response vector, and may provide, addressed to the electronic device, the response vector.

### CROSS-REFERENCE TO RELATED APPLICATIONS

This application is a Continuation-in-Part of U.S. Non-Provisional Application Ser. No. 19/282,732, “Dynamic Content Window Based on Context,” filed on Jul. 28, 2025, by Pascal Ralph Manfred Simpkins, et al., which claims priority under 35 U.S.C. 119(e) to U.S. Provisional Application Ser. No. 63/777,214, “Dynamic Content Window Based on Context,” filed on Mar. 25, 2025, by Pascal Ralph Manfred Simpkins, et al., the contents of both of which are herein incorporated by reference.

### STATEMENT REGARDING FEDERALLY SPONSORED RESEARCH OR DEVELOPMENT

Not Applicable.

### FIELD

The described embodiments relate to dynamically adapting a length of a content window for a pretrained neural network based at least in part on a environmental information and/or a context associated with the environmental information.

### INTRODUCTION

Advances in neural networks (which are sometimes referred to as ‘artificial neural networks’) have led to their widespread adoption in a variety of applications. For example, convolutional network networks (CNNs) are routinely used for processing information, such as for image processing.

In a typical application of a pretrained neural network for image processing, a content window is often used to facilitate the identification of objects patterns or features in an image. A ‘content window’ usually refers to a sliding window that is slide across an image. Moreover, a CNN is used to analyze the content (such as the pixels) within the content window.

Usually, a content window has a fixed size or length (such as a predefined box or set of pixels). However, this architecture typically adversely impacts the performance of CNNs and, more generally, pretrained neural networks. In particular, fixed content windows often have a large size. In turn, this results in large memory and processing requirements, with commensurate impact on power consumption and analysis time. Consequently, the use of a fixed content window often adversely impacts the performance of pretrained neural networks.

### SUMMARY

In a first group of embodiments, a computer system that determines a dynamic content window is described. This computer may include: an interface circuit that communicates with an electronic device; a computation device (such as a processor, a graphics processing unit or GPU, etc.) that executes program instructions; and memory that stores the program instructions. During operation, the computer system receives, from the electronic device, an input vector. Then, the computer system accesses, in a graph database, information specifying a context associated with the input vector. Moreover, the computer system determines a dynamic content window based at least in part on the context, where the dynamic content window specifies a subset of content in the input vector, and the dynamic content window has a length less than a predefined value. Next, the computer system provides, to a pretrained neural network, the input vector and the dynamic content window. Furthermore, the computer system receives, from the pretrained neural network, a response vector, and provides, addressed to the electronic device, the response vector.

Note that the graph database (or data structure) may include a vector graph database.

Moreover, the pretrained neural network may include a large language model (LLM).

Furthermore, during operation, the computer system may update, in the graph database, the context based at least in part on the input vector and the response vector.

Additionally, the input vector may correspond to: software code, a portion of a narrative, or a portion of a conversation between an individual and the pretrained neural network.

In some embodiments, the predefined value may be less than or equal to 8,095 tokens. Alternatively or additionally, the predefined value may be significantly smaller than 128,000 tokens.

Moreover, the dynamic content window may correspond to a next or subsequent operation in an interaction between the electronic device and the pretrained neural network.

Furthermore, the pretrained neural network may be implemented using a second computer system, where the second computer system is different from the computer system.

Additionally, the response vector may be based at least in part on the input vector and the dynamic content window.

In some embodiments, the pretrained neural network may include one or more convolutional layers, one or more residual layers and one or more dense layers. Note that a given node in a given layer in the pretrained neural network may include an activation function that includes: a rectified linear activation function (ReLU), a leaky ReLU, an exponential linear unit (ELU) activation function, a parametric ReLU, a tanh activation function, and/or a sigmoid activation function.

Another embodiment provides the electronic device.

Another embodiment provides a computer for use, e.g., in the computer system.

Another embodiment provides a computer-readable storage medium for use with the electronic device, the computer or the computer system. When executed by the electronic device, the computer or the computer system, this computer-readable storage medium causes the electronic device, the computer or the computer system to perform at least some of the aforementioned operations.

Another embodiment provides a method, which may be performed by the electronic device, the computer or the computer system. This method includes at least some of the aforementioned operations.

In a second group of embodiments, a computer system that determines a dynamic content window is described. This computer may include: an interface circuit that communicates with an electronic device; a computation device (such as a processor, a graphics processing unit or GPU, etc.) that executes program instructions; and memory that stores the program instructions. During operation, the computer system receives information associated with an environment of an electronic device. Then, the computer system accesses a stored context corresponding to the information. Moreover, the computer system determines a dynamic content window based at least in part on the information, the context, or both, where the dynamic content window has a length less than a predefined value. Next, the computer system generates an input vector based at least in part on the information, the context and the dynamic content window. Furthermore, the computer system provides, to a pretrained neural network, the input vector and the dynamic content window. Additionally, the computer system receives, from the pretrained neural network, a response vector, and provides, addressed to the electronic device, the response vector.

In some embodiments, the computer system modifies the dynamic content window based at least in part on the response vector.

Note that the context may be stored in a graph database (or data structure). For example, the graph database may include a vector graph database.

Moreover, the pretrained neural network may include a large language model (LLM).

Furthermore, during operation, the computer system may update the context based at least in part on the information, the input vector and/or the response vector.

Additionally, the input vector may correspond to: software code, a portion of a narrative, or a portion of a conversation between an individual and the pretrained neural network.

In some embodiments, the predefined value may be less than or equal to 8,095 tokens. Alternatively or additionally, the predefined value may be significantly smaller than 128,000 tokens.

Moreover, the dynamic content window may correspond to a next or subsequent operation in an interaction between the electronic device and the pretrained neural network.

Furthermore, the pretrained neural network may be implemented using or hosted by a second computer system, where the second computer system is different from the computer system.

Additionally, the response vector may be based at least in part on the input vector and the dynamic content window.

In some embodiments, the pretrained neural network may include one or more convolutional layers, one or more residual layers and one or more dense layers. Note that a given node in a given layer in the pretrained neural network may include an activation function that includes: a rectified linear activation function (ReLU), a leaky ReLU, an exponential linear unit (ELU) activation function, a parametric ReLU, a tanh activation function, and/or a sigmoid activation function.

Moreover, the information may include: real-time data associated with the environment, facial recognition data, location data, image recognition data, audio, one or more images, object detection data, or another type of sensor data.

Furthermore, prior to accessing the context, the computer system may normalized the information.

Another embodiment provides the electronic device.

Another embodiment provides a computer for use, e.g., in the computer system.

Another embodiment provides a computer-readable storage medium for use with the electronic device, the computer or the computer system. When executed by the electronic device, the computer or the computer system, this computer-readable storage medium causes the electronic device, the computer or the computer system to perform at least some of the aforementioned operations.

Another embodiment provides a method, which may be performed by the electronic device, the computer or the computer system. This method includes at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### DRAWINGS

FIG. 1 is a block diagram illustrating an example of a computer system in accordance with an embodiment of the present disclosure.

FIG. 2 is a flow diagram illustrating an example of a method for determining a dynamic content window using a computer system in FIG. 1 in accordance with an embodiment of the present disclosure.

FIG. 3 is a drawing illustrating an example of communication between components in a computer system in FIG. 1 in accordance with an embodiment of the present disclosure.

FIG. 4 is a flow chart illustrating contextual response generation and knowledge accumulation in accordance with an embodiment of the present disclosure.

FIG. 5 is a block diagram illustrating a dynamic context system that uses a graph database in accordance with an embodiment of the present disclosure.

FIG. 6 is a flow chart illustrating a data retrieval and content window construction in accordance with an embodiment of the present disclosure.

FIG. 7 is a drawing illustrating connections between different types of entities in accordance with an embodiment of the present disclosure.

FIG. 8 is a flow chart illustrating context node crawling in accordance with an embodiment of the present disclosure.

FIG. 9 is a flow chart illustrating adaptive content windows in accordance with an embodiment of the present disclosure.

FIG. 10 is a drawing illustrating a push-pull graph system workflow in accordance with an embodiment of the present disclosure.

FIG. 11 is a block diagram illustrating a system architecture in accordance with an embodiment of the present disclosure.

FIG. 12 is a flow chart illustrating a workflow for adaptive use cases in accordance with an embodiment of the present disclosure.

FIG. 13 is a drawing illustrating retrieving, evaluating, and refining of contextual knowledge in accordance with an embodiment of the present disclosure.

FIG. 14 is a drawing illustrating swarm-based summation in accordance with an embodiment of the present disclosure.

FIG. 15 is a drawing illustrating the building of relevant and summarized context in accordance with an embodiment of the present disclosure.

FIG. 16 is a flow diagram illustrating an example of a method for determining a dynamic content window using a computer system in FIG. 1 in accordance with an embodiment of the present disclosure.

FIG. 17 is a drawing illustrating an example of communication between components in a computer system in FIG. 1 in accordance with an embodiment of the present disclosure.

FIG. 18 is a drawing illustrating an example of interactions among components in a computer system in FIG. 1 in accordance with an embodiment of the present disclosure.

FIG. 19 is a block diagram illustrating an example of a computer in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In a first group of embodiments, a computer system that determines a dynamic content window is described. This computer may include: an interface circuit that communicates with an electronic device (which may be external or internal to the computer system); a computation device (such as a processor, a graphics processing unit or GPU, etc.) that executes program instructions; and memory that stores the program instructions. During operation, the computer system receives, from the electronic device, an input vector. Then, the computer system accesses, in a graph database (such as a vector graph database), information specifying a context associated with the input vector. Moreover, the computer system determines a dynamic content window based at least in part on the context, where the dynamic content window specifies a subset of content in the input vector, and the dynamic content window has a length less than a predefined value. Next, the computer system provides, to a pretrained neural network, the input vector and the dynamic content window. Furthermore, the computer system receives, from the pretrained neural network, a response vector, and provides, addressed to the electronic device, the response vector.

By determining the dynamic content window, these analysis techniques may significantly reduce the amount of memory, processing capability and communication resources needed during operation of the pretrained neural network. Moreover, the analysis techniques may significantly reduce the power consumption and analysis time used during operation of the pretrained network work. Consequently, the analysis techniques may significantly improve the performance of the pretrained neural network and may significantly reduce the cost of operating the pretrained neural network. These advances may address technological limitations of many pretrained neural networks (such as LLMs), which may allow the advantages offered by these pretrained neural networks to be leveraged without requiring the architectural or training of the pretrained neural networks to be changed. Therefore, the analysis techniques may improve the user experience when operating and/or using the pretrained neural networks.

In a second group of embodiments, a computer system that determines a dynamic content window is described. During operation, the computer system may receive information associated with an environment of an electronic device. Then, the computer system may access a stored context corresponding to the information. Moreover, the computer system may determine a dynamic content window based at least in part on the information and/or the context, where the dynamic content window has a length less than a predefined value. Next, the computer system may generate an input vector based at least in part on the information, the context and the dynamic content window. Furthermore, the computer system may provide, to a pretrained neural network, the input vector and the dynamic content window. Additionally, the computer system may receive, from the pretrained neural network, a response vector, and may provide, addressed to the electronic device, the response vector.

By determining the dynamic content window, these analysis techniques may allow the computer system to dynamically adapt the input vector to changes in the environment. In the process, the computer system may be able to query and receive responses (such as the response vector) corresponding to the environmental conditions (such as the presence of an individual in the environment). Moreover, by determining the dynamic content window (which may be significantly smaller than existing predefined content windows), the analysis techniques may significantly reduce the amount of memory, processing capability and/or communication resources needed during operation of the pretrained neural network. Moreover, the analysis techniques may significantly reduce the power consumption and/or analysis time used during operation of the pretrained network work. Consequently, the analysis techniques may significantly improve the performance of the pretrained neural network and may significantly reduce the cost of operating the pretrained neural network (including the computer system that generates and provides the input vector, and a second computer system that implements or hosts the pretrained neural network). These advances may address technological limitations of many pretrained neural networks (such as LLMs), which may allow the advantages offered by these pretrained neural networks to be leveraged without requiring the architectural or training of the pretrained neural networks to be changed. Therefore, the analysis techniques may improve the user experience when operating and/or using the pretrained neural networks.

In the discussion that follows, the analysis techniques are used to analyze a wide variety of types of data or inputs, including or corresponding to: images (such as ultrasound images corresponding to wavelengths between 0.2 and 1.9 mm, Infra-red images corresponding to one or more wavelengths between 700 nm and 1 mm, optical images corresponding to one or more visible wavelengths between 300 and 800 nm, ultraviolet images corresponding to ultraviolet wavelengths between 10 and 400 nm, or X-ray images corresponding to one or more wavelengths between 0.01 and 10 nm), software code, medical data (such as data associated with an electronic medical record), financial data, economic data, data associated with a database or data structure, and/or natural language (such as a portion of a narrative, or a portion of a conversation, e.g., between an individual and a pretrained neural network).

In some embodiments, the analysis techniques may use one or more neural networks or analysis models that are pretrained or predetermined using a machine-learning technique (such as a supervised learning technique, an unsupervised learning technique and/or a neural network) and a training dataset. For example, the analysis model may include a classifier or a regression model that was trained using: a support vector machine technique, a classification and regression tree (CART) technique, logistic regression, LASSO, linear regression, nonlinear regression, a K nearest-neighbors technique (where K is a non-zero integer), a generative model, a Fisher discriminator, a kernel method, a decision tree, a random forest, a boosting technique, a linear perceptron, a neural network technique (such as a CNN, an LLM, an autoencoder neural network, a feedforward neural network, a generative adversarial neural network, a multilayer perceptron neural network, a long short-term memory neural network, a radial basis function neural network, or another type of neural network) and/or another linear or nonlinear supervised-learning technique.

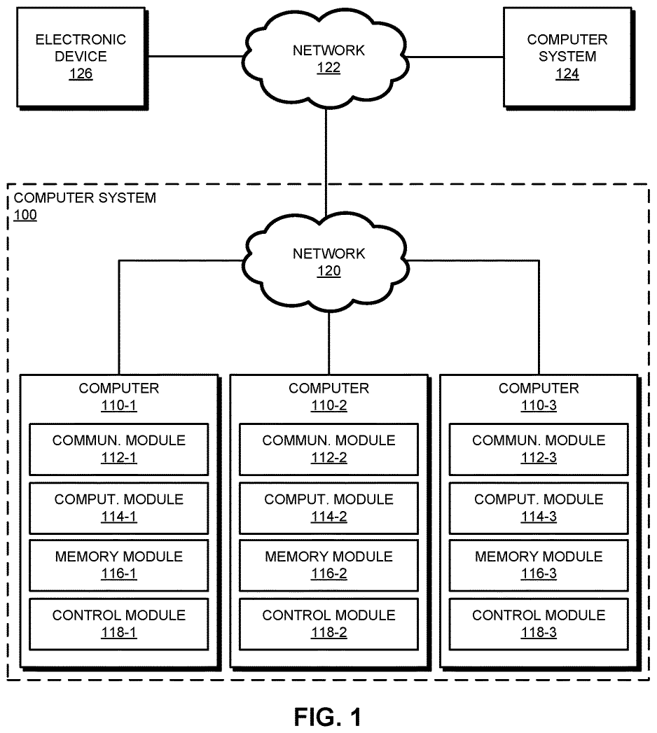

We now describe embodiments of the analysis techniques. Notably, in the discussion that follows, the analysis techniques are used to determine a dynamic content window for a pretrained neural network (such as an LLM) based at least in part on a context (which may be predetermined and stored in a graph database) associated with an input vector to the pretrained neural network. Note that a ‘content window’ is sometimes referred to as a ‘context window.’ FIG. 1 presents a block diagram illustrating an example of a computer system 100. This computer system may include one or more computers 110. These computers may include: communication modules 112, computation modules 114, memory modules 116, and optional control modules 118. Note that a given module or engine may be implemented in hardware and/or in software.

Communication modules 112 may communicate frames or packets with data or information (such as input vectors or control instructions) between computers 110 via a network 120 (such as the Internet and/or an intranet). For example, this communication may use a wired communication protocol, such as an Institute of Electrical and Electronics Engineers (IEEE) 802.3 standard (which is sometimes referred to as ‘Ethernet’) and/or another type of wired interface. Alternatively or additionally, communication modules 112 may communicate the data or the information using a wireless communication protocol, such as: an IEEE 802.11 standard (which is sometimes referred to as ‘Wi-Fi’, from the Wi-Fi Alliance of Austin, Texas), Bluetooth (from the Bluetooth Special Interest Group of Kirkland, Washington), a third generation or 3G communication protocol, a fourth generation or 4G communication protocol, e.g., Long Term Evolution or LTE (from the 3rd Generation Partnership Project of Sophia Antipolis, Valbonne, France), LTE Advanced (LTE-A), a fifth generation or 5G communication protocol, other present or future developed advanced cellular communication protocol, Citizens Broadband Radio Service (CBRS), and/or another type of wireless interface or wireless communication protocol. For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies.

In the described embodiments, processing a packet or a frame in a given one of computers 110 (such as computer 110-1) may include: receiving the signals with a packet or the frame; decoding/extracting the packet or the frame from the received signals to acquire the packet or the frame; and processing the packet or the frame to determine information contained in the payload of the packet or the frame. Note that the communication in FIG. 1 may be characterized by a variety of performance metrics, such as: a data rate for successful communication (which is sometimes referred to as ‘throughput’), an error rate (such as a retry or resend rate), a mean squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). Note that wireless communication between components in FIG. 1 may use one or more bands of frequencies, such as: 900 MHz, 2.4 GHz, 5 GHz, 6 GHz, 60 GHz, the CBRS (e.g., a frequency band near 3.5 GHz), and/or a band of frequencies used by LTE or another cellular-telephone communication protocol or a data communication protocol. In some embodiments, the communication between the components may use multi-user transmission (such as orthogonal frequency division multiple access or OFDMA).

Moreover, computation modules 114 may perform calculations using: one or more microprocessors, ASICs, microcontrollers, programmable-logic devices, GPUs and/or one or more digital signal processors (DSPs). Note that a given computation component is sometimes referred to as a ‘computation device’.

Furthermore, memory modules 116 may access stored data or information in memory that local in computer system 100 and/or that is remotely located from computer system 100. Notably, in some embodiments, one or more of memory modules 116 may access stored information (such a context associated with an input vector) in a graph database (e.g., a vector graph database) or data structure. Alternatively or additionally, in other embodiments, one or more memory modules 116 may access, via one or more of communication modules 112, stored information in the remote memory in computer system 124, e.g., via network 120 and network 122. Note that network 122 may include: the Internet and/or an intranet. However, in other embodiments, the context may be determined in real-time or on-the-fly and, thus, may not be predetermined and stored in memory.

While FIG. 1 illustrates computer system 100 at a particular location, in other embodiments at least a portion of computer system 100 is implemented at more than one location. Thus, in some embodiments, computer system 100 is implemented in a centralized manner, while in other embodiments at least a portion of computer system 100 is implemented in a distributed manner. This remote processing may reduce the amount of data that is communicated via network 120 and network 122.

Although we describe the computation environment shown in FIG. 1 as an example, in alternative embodiments, different numbers or types of components may be present in computer system 100. For example, some embodiments may include more or fewer components, a different component, and/or components may be combined into a single component, and/or a single component may be divided into two or more components.

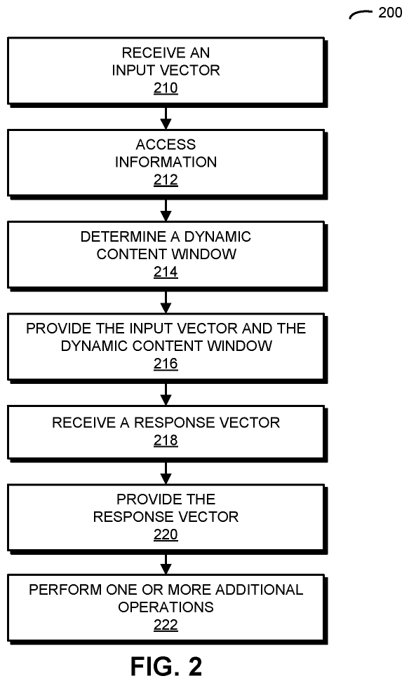

As discussed previously, existing pretrained neural networks often use a fixed (and large) content window. This can degrade the performance of the pretrained neural networks. Moreover, as described further below with reference to FIGS. 2-15, in order to address these challenges computer system 100 may perform the analysis techniques. Notably, during the analysis techniques, one or more of optional control modules 118 may divide the analysis among computers 110. Then, a given computer (such as computer 110-1) may perform at least a designated portion of the analysis. For example, computation module 114-1 may access information (e.g., using memory module 116-1) specifying context.

During operation, communication module 112-1 receive, from electronic device 126, an input vector. Then, computation module 114-1 may access, in a graph database (such as a vector graph database) in or associated with memory module 116-1, information specifying a context associated with the input vector. Moreover, computation module 114-1 may determine a dynamic content window based at least in part on the context, where the dynamic content window specifies a subset of content in the input vector, and the dynamic content window has a length less than a predefined value.

Next, computation module 114-1 may provide, to a pretrained neural network (such as an LLM), the input vector and the dynamic content window. Note that the pretrained neural network may be implemented by computer system 100. Alternatively, the pretrained neural network may be implemented remotely, e.g., by another computer system (not shown). In these embodiments, computation module 114-1 may provide the input vector and the dynamic content window to the (remote) pretrained neural network using communication module 112-1.

Furthermore, computation module 114-1 may receive, from the pretrained neural network, a response vector. Additionally, computation module 114-1 may instruct communication module 112-1 to provide one or more packets or frames, addressed to electronic device 126, the response vector. In some embodiments, computation module 114-1 may update, using memory module 116-1 and in the graph database, the context based at least in part on the input vector and the response vector.

In these ways, computer system 100 may reduce the amount of system resources used during operation of the pretrained neural network. For example, by determining the dynamical content window, computer system 100 may reduce the amount of memory, processing capability and communication resources needed during operation of the pretrained neural network, and thus may significantly reduce the power consumption and analysis time used during operation of the pretrained network work. For example, after 50 back-and-forth interactions in a conversation, the content window may have used 32,400 tokens (versus 1.7 M tokens with the existing content window techniques) or a power reduction of 98.1%. Moreover, the cost may be $0.32 (versus $1735 with the existing content window techniques) or a cost reduction of 98.2%. These advances may address technological limitations of many pretrained neural networks (such as LLMs), which may allow the advantages offered by these pretrained neural networks to be leveraged without requiring the architectural or training of the pretrained neural networks to be changed. Consequently, computer system 100 may improve the user experience when operating and/or using the pretrained neural networks.

We now describe embodiments of the method. FIG. 2 presents a flow diagram illustrating an example of a method 200 for determining a dynamic content window, which may be performed by a computer system (such as computer system 100 in FIG. 1). During operation, the computer system may receive, from an electronic device, an input vector (operation 210). Then, the computer system may access, in a graph database, information (operation 212) specifying a context associated with the input vector. Moreover, the computer system may determine the dynamic content window (operation 214) based at least in part on the context, where the dynamic content window specifies a subset of content in the input vector, and the dynamic content window has a length less than a predefined value. Next, the computer system may provide, to a pretrained neural network, the input vector and the dynamic content window (operation 216). Furthermore, the computer system may receive, from the pretrained neural network, a response vector (operation 218) or output, and may provide, addressed to the electronic device, the response vector (operation 220).

Note that the graph database (or data structure) may include a vector graph database.

Moreover, the pretrained neural network may include an LLM.

Furthermore, the input vector may correspond to: software code, a portion of a narrative, or a portion of a conversation between an individual and the pretrained neural network.

In some embodiments, the predefined value may be less than or equal to 8,095 tokens (or, equivalently, 6,000 words). Alternatively or additionally, the predefined value may be significantly smaller than 128,000 tokens.

Moreover, the dynamic content window may correspond to a next or subsequent operation in an interaction between the electronic device and the pretrained neural network.

Furthermore, the pretrained neural network may be implemented using a second computer system, where the second computer system is different from the computer system.

Additionally, the response vector may be based at least in part on the input vector and the dynamic content window.

In some embodiments, the pretrained neural network may include one or more convolutional layers, one or more residual layers and one or more dense layers. Note that a given node in a given layer in the pretrained neural network may include an activation function that includes: a ReLU, a leaky ReLU, an ELU activation function, a parametric ReLU, a tanh activation function, and/or a sigmoid activation function.

In some embodiments, the computer system may optionally perform one or more additional operations (operation 222). For example, during operation, the computer system may update, in the graph database, the context based at least in part on the input vector and the response vector.

In some embodiments of method 200, there may be additional or fewer operations. Furthermore, the order of the operations may be changed, and/or two or more operations may be combined into a single operation.

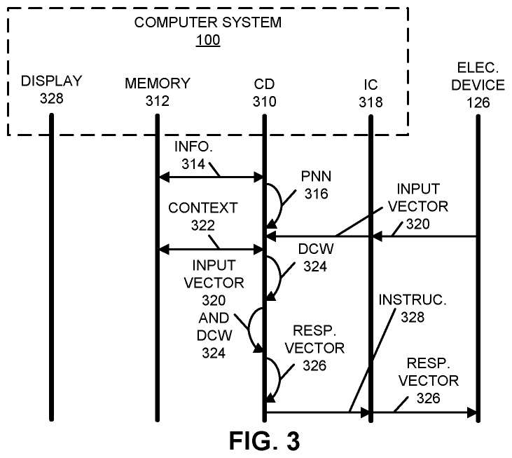

Embodiments of the analysis techniques are further illustrated in FIG. 3, which presents a drawing illustrating an example of communication among components in computer system 100. In FIG. 3, a computation device (CD) 310 (such as a processor or a GPU) in computer system 100 may access, in memory 312 in computer system 100, information 314 specifying configuration instructions and hyperparameters for a pretrained neural network (PNN) 316. After receiving the configuration instructions and the hyperparameters, computation device 310 may implement the pretrained neural network 316.

Moreover, an interface circuit (IC) 318 in computer system 100 may receive, from electronic device 126, an input vector 320, which may be provided to computation device 310. Then, computation device 310 may access, in a graph database in memory 312, information specifying a context 322 associated with input vector 320.

Furthermore, computation device 310 may determine the dynamic content window (DCW) 324 based at least in part on context 322, where the dynamic content window 324 specifies a subset of content in input vector 320, and the dynamic content window has a length less than a predefined value.

Next, computation device 310 may provide, to pretrained neural network 316, input vector 320 and the dynamic content window 324. Furthermore, computation device 310 may receive, from pretrained neural network 316, a response vector 326.

Additionally, computation device 310 may provide an instruction 328 to interface circuit 318 to provide, addressed to electronic device 126, response vector 326.

While FIG. 3 illustrates communication between components using unidirectional or bidirectional communication with lines having single arrows or double arrows, in general the communication in a given operation in this figure may involve unidirectional or bidirectional communication. Moreover, while FIG. 3 illustrates operations being performed sequentially or at different times, in other embodiments at least some of these operations may, at least in part, be performed concurrently or in parallel.

We now further describe embodiments of the analysis techniques. The disclosed analysis techniques provide a dynamic artificial intelligence (AI) context system that may seamlessly integrate one or more adaptive graph databases with language model agents operating in a distributed framework. This design may enable real-time, scalable, and self-updating interactions for a wide range of AI-driven applications. Unlike traditional monolithic approaches, which are often rigid and resource-intensive, this approach may employ asynchronous data retrieval and distributed processing to achieve unparalleled scalability, efficiency, and fault tolerance.

In some embodiments, the disclosed analysis techniques may include real-time knowledge evolution. With every interaction, the computer system may retrieve and process relevant information from an adaptive graph database, while also storing new knowledge (or updates) automatically. This capability may ensure that the computer system continuously evolves, thereby maintaining long-term context and consistency without overwhelming the processing capacity of the pretrained neural network. The selective filtering and content window optimization in the analysis techniques may allow the computer system to handle large-scale, complicated datasets while retaining access to full historical knowledge.

In order to address the limitations of traditional AI systems (such as difficulties in maintaining coherent long-term context, managing vast datasets, and dynamically integrating new information), the analysis techniques may incorporate one or more of: distributed context processing (such as asynchronous ingestion and processing of vast datasets to reduce the computational load on individual systems, thereby enabling faster and more efficient operations); self-updating knowledge store (in which newly generated or learned information may be automatically structured and integrated into a graph database, thereby ensuring consistent and reliable knowledge retention); a scalable graph-database architecture (e.g., a dynamic, graph-based framework that efficiently stores, updates, and queries interconnected data at scale); contextual node crawling (which may provide efficient traversal of graph nodes and edges using relevance scoring and dynamic depth control to retrieve only necessary information); adaptive content windows (in which the use of real-time adjustment of content windows may ensure that only the most relevant information is passed to the pretrained neural network, thereby helping to maintain coherence over extended interactions); and/or relevance filtering and vectorization (in which graph traversal may be combined with vector embeddings to enhance precision and streamline downstream AI model processing).

The disclosed analysis techniques may be used with applications that require persistent memory, scalable performance, and real-time adaptability. It may support use cases such as: adaptive knowledge systems, personalized learning environments, real-time storytelling, and/or enterprise-level AI workflows. In the process, the analysis techniques may provide a blend of flexibility, efficiency, and contextual accuracy. This approach may revolutionize generative AI by delivering smarter, context-aware interactions that are highly scalable, cost-effective, and capable of long-term knowledge retention.

Moreover, the disclosed analysis techniques may address shortcomings in generative AI systems and/or may unlock opportunities in a variety of industries that require long-term coherence, real-time adaptability, and resource efficiency. Notably, the analysis techniques may facilitate the retention of long-term context across interactions. Existing systems often struggle to maintain coherence over extended interactions. They are often limited by static memory models or session-based content windows, which usually lose track of prior inputs once the session ends. This may restrict the ability of AI (or neural networks) to function effectively in tasks requiring continuity, such as personalized learning, long-term medical care, or legal research. In the disclosed analysis techniques, persistent, real-time memory may be introduced by leveraging a graph database that stores and retrieves contextual knowledge dynamically. This may enable: AI-powered systems (e.g., tutors, therapists, customer service agents, etc.) to remember prior user interactions across days, weeks, or years, thereby providing a seamless and coherent experience; and/or advanced continuity in fields like research assistance or legal case preparation.

Furthermore, the analysis techniques may provide scalability and resource efficiency. Existing AI solutions are often tied to large, resource-intensive models with massive content windows, which can be computationally expensive and environmentally taxing. Conversely, smaller models with lower memory capabilities often lack the sophistication to perform well without overwhelming context sizes. In the disclosed analysis techniques, models of all sizes (small, medium, and/or large) may operate efficiently by including one or more of: adaptive content windows that retrieve only the most relevant data, and which may be tailored to the processing capacity associated with a pretrained neural network or model; and/or the ability to maintain high performance without needing computationally expensive monolithic systems (this may democratize AI capabilities, thereby making advanced systems accessible to smaller organizations with limited resources).

Additionally, the analysis techniques may provide a greener approach to AI through optimized resource usage, which may contribute to sustainability goals by reducing computation and energy requirements.

In some embodiments, the analysis techniques may facilitate real-time learning and knowledge integration. Traditional generative AI systems typically do not have the ability to learn or adapt dynamically during interactions. Most of these existing approaches require retraining, manual updates, or explicit developer intervention to incorporate new knowledge. This can create delays in responsiveness to emerging information, limit the flexibility of applications, and/or increase operational costs. IN the disclosed analysis techniques, the self-updating knowledge store may allow the AI to: assimilate new information rapidly and to add it to the knowledge graph; adapt its understanding and responses in real time, which may be useful for applications such as: crisis management, financial market analysis, and/or evolving customer support systems; and/or deliver insights that are current and relevant, thereby reducing downtime and ensuring the computer system is as dynamic as the environments it operates in.

Note that the analysis techniques may provide insights ranging from obvious to deep contexts. Traditional systems often struggle to handle complicated queries or to derive insights from interrelated data. Current approaches often focus only on surface-level context, which may leave nuanced or hidden patterns unexamined. By leveraging contextual node crawling and/or graph-based intelligence, the disclosed analysis techniques may dynamically retrieve surface-level and/or deep contextual information. These capabilities may: enable discovery of hidden relationships or patterns, such as subtle trends in customer behavior or correlations between unrelated variables in financial datasets; and/or enhanced decision-making capabilities in fields such as medicine, where deep contextual awareness could may reveal links between symptoms, environmental factors, and/or treatment outcomes.

Moreover, the analysis techniques may provide real-time adaptability and flexibility. Existing AI systems often perform poorly when the scope of interaction changes rapidly or when unexpected contexts are introduced. Typically, static adaptability models cannot adjust in real time without reprogramming or retraining. In contrast, the analysis techniques may provide real-time adaptability through: dynamic updates to the adaptive graph database to respond to emerging needs and evolving conditions seamlessly; and/or versatility in handling dynamic, multi-turn conversations where the context changes unpredictably, such as in disaster response systems or interactive storytelling.

Furthermore, the analysis techniques may provide enhanced resource cost management. Existing AI systems usually rely on large-scale models for sophisticated tasks, which may result in inflated operational costs and may make them inaccessible to smaller enterprises or non-profits. The disclosed analysis techniques may redefine the cost-performance balance by enabling: smaller, resource-efficient models (such as a pretrained neural network) to deliver high-quality results with contextual precision; flexible use of distributed agents, which may allow tasks to be split across smaller compute systems, and which may reduce the need for large-scale, centralized resources; cost-effectiveness in deploying scalable AI solutions for businesses of all sizes, thereby enabling broader adoption of advanced AI technologies.

Thus, the analysis techniques may address foundational inefficiencies in existing AI systems while opening doors to revolutionary applications. By introducing techniques for long-term memory, real-time learning, and/or contextual depth, the analysis techniques may help address the problems of scalability, coherence, adaptability, and/or resource cost. Applications of the analysis techniques may span diverse industries, creating opportunities for innovation in fields ranging from adaptive learning and personalized healthcare to smart cities and dynamic marketing systems.

The analysis techniques may manage user interactions intelligently, thereby providing precise and contextually relevant responses while maintaining coherence over extended conversations. A computer system that implements the analysis techniques may provide an advanced, adaptive engine for processing and managing AI interactions. Its primary functions may include: dynamic context management, e.g., via a visible content window (in which the interaction may be presented to the user, and which may include information explicitly relevant to the query from a user); and a hidden content window (with a filtered subset of data retrieved from the knowledge database, which may be used internally by the pretrained neural network to generate accurate, context-driven responses); query refinement and precision (which may enhance user queries by identifying implicit and explicit entities, e.g., names, places, or objects, and may formulates precise database queries to extract relevant data); real-time knowledge integration (which may extract, structure, and/or incorporate information gained during interactions into the knowledge graph for future reference or use); relevance filtering (which may filter out irrelevant or excessive information to streamline processing and help ensure concise, accurate responses); response generation (which may produce coherent and contextually accurate answers based at least in part on the combined data from the hidden content window and user queries or input vectors); and/or information ingestion and database generation (which may identifies entity types, properties, relationship structures, and entities from dynamic input types to generate or modify reference graph-database components).

We now describe workflows in the analysis techniques. Notably, in some embodiments, the analysis techniques may include several stages, which combine graph-database management, language-model (or LLM) processing, and contextual filtering to provide efficiency and relevance. A first stage may include use input and query submission. In the first stage, a user interacts with the computer system, submitting a query through the user-facing model. For example, a user may ask: ‘What types of donuts are available at Joe's Bakery?’ The visible content window may initially contain only the input (or input vector) from the user. In response, the computer system may parse the user query to identify entities (e.g., ‘Joe's Bakery’ and ‘donuts;) and their relationships. Implicit entities or additional clarifications may also be extracted (e.g., recognizing ‘available’ implies inventory or a menu).

A second stage may include entity expansion and query transformation. Notably, the computer system may refine the query of the user by adding contextual details based on the entities identified. For example, an original query may be: ‘What types of donuts are available at Joe's Bakery?’ The transformed query may be: ‘Retrieve a list of donuts currently available at Joe's Bakery.’ This stage may involve the language model or summarization component expanding the query by referencing known relationships in a graph database. A cypher query or equivalent database query may be generated. This query may specifically target the relevant node(s) and edges in a knowledge graph.

Moreover, a third stage may include database query and information retrieval. Notably, the query may be executed on an adaptive graph database to retrieve information about the relevant entities (e.g., ‘Joe's Bakery’ and ‘donuts’). Only information relevant to the query (e.g., a list of available donuts) may be pulled into the hidden content window. This stage may involve contextual node crawling. For example, the computer system may traverse the graph database, starting with the bakery node. It may follow edges labeled as ‘sells’or ‘has inventory’ to retrieve related nodes representing donut types. In addition, relevance filtering in which irrelevant information (such as calorie counts, a bakery address, or historical sales data) may be excluded unless explicitly relevant to the query.

A fourth stage may include summarization and context construction. Notably, the retrieved data may be summarized into concise, readable information for the hidden content window. For example, raw data, such as ‘Joe's Bakery has inventory nodes for chocolate donuts, glazed donuts, and jelly donuts, each with additional metadata like calories, supplier info, etc.’ Moreover, a hidden context may be summarized, such as ‘Joe's Bakery offers chocolate, glazed, and jelly donuts.’ The summarization model (such as program instructions or a pretrained neural network) may process the raw data to: remove redundant or extraneous details; and/or Format the relevant information concisely for the language model (or another pretrained neural network).

Furthermore, a fifth stage may include response generation. Notably, the language model or LLM may combine the user query (visible context) with the hidden context to generate an appropriate response. For example, the response to user may be: ‘Joe's Bakery offers chocolate, glazed, and jelly donuts.’ In order to do this, the language model may use the hidden context as a factual basis to craft a response tailored to the original query. When the user follows up with additional questions (e.g., ‘What are the most popular?’), the computer system may dynamically update the content windows and retrieve additional data as necessary.

A sixth stage may include knowledge integration. Notably, any new or update information provided during the interaction (e.g., ‘Joe's Bakery is known for its jelly donuts’) may be identified, structured, and added to the graph database for future use. For example, a new node may be added: ‘Joe's Bakery’->‘is known for’->‘jelly donuts.’ In order to do this, the computer system may summarize the new information and represents it as a new node or edge in the graph database. Moreover, consistency checks may ensure the data does not conflict with existing information.

The analysis techniques may offer clear advantages over both current state-of-the-art systems and potential hypothetical alternatives. Notably, the analysis techniques may provide long-term context retention. Current AI systems often rely on static memory models or large content windows, which ‘forget’ information or loose coherence after a session, require inefficient appending of prior interactions, and/or are usually resource intensive. This can lead to a loss of coherence in long-term conversations. Moreover, hypothetical alternatives may attempt to solve this by extending content windows further or storing embeddings, but this would result in significant computational overhead and degraded performance over time. In contrast, the disclosed analysis techniques may solve the problem with a graph-based long-term memory, allowing it to persist and recall context dynamically, without bloating the content window. This may maintain coherence across extended interactions, independent of their duration.

Moreover, the analysis techniques may provide scalability across model or pretrained neural network sizes. Current systems often rely on monolithic architectures and massive models to achieve high performance, making them inaccessible to smaller organizations due to high computational costs. Hypothetical alternatives may address this by building specialized smaller models for specific tasks, but these are often constrained by limited functionality and lack the ability to scale efficiently. In contrast, the disclosed analysis techniques may enable small, medium, and large models to achieve comparable performance by optimizing content windows and leveraging distributed agent systems, making it both cost-effective and scalable.

Furthermore, the analysis techniques may provide real-time knowledge updates. Existing solutions typically require manual interventions or periodic retraining to incorporate new knowledge into their operational memory, leading to delays and inefficiencies. A hypothetical alternative may use a combination of embedding updates and periodic re-indexing, but this would likely lack the flexibility and precision needed for real-time interactions. In contrast, the disclosed analysis techniques may integrate real-time updates through a push technique, rapidly or instantly updating its graph database with new information. This may ensure rapid or immediate adaptability without the need for downtime or retraining.

Additionally, the analysis techniques may provide relevance filtering and precision. Current AI systems usually retrieve broad sets of information, often resulting in irrelevant or extraneous details being included in responses. Users often must sift through unnecessary data manually. Alternatives may employ more-complicated embeddings or vector-based retrieval techniques, but these often fail to prioritize specific task relevance and can overload models with excessive data. In contrast, the disclosed analysis techniques may employ contextual node crawling and relevance filtering, retrieving only the most pertinent data from its graph database. This may avoid overloading the language model with unnecessary information, ensuring concise and focused responses.

In some embodiments, the analysis techniques may provide plug-and-play simplicity. Current systems typically require significant expertise in graph databases, language model integration, and distributed architectures to deploy and operate effectively. This can create a steep learning curve for implementation. A potential alternative may abstract some complexity for the user, but could still require manual setup of infrastructure or domain-specific integration. In contrast, the disclosed analysis techniques may be designed to function as a plug-in for language model agents, abstracting its own complexity. Users may not need to understand the inner workings of graph databases, distributed systems, or integration mechanics. This may allow the computer system to operate autonomously, providing advanced functionality with minimal setup or expertise.

Note that the analysis techniques may provide reduced resource costs. Systems like GPT-based architectures often demand enormous computational resources to maintain large content windows or to train and deploy largescale models, making them inaccessible to smaller organizations. Hypothetical systems may address this by reducing model size or content window size, but these approaches sacrifice precision and functionality in the process. In contrast, the disclosed analysis techniques may optimize resource usage by dynamically adjusting content windows, enabling smaller models to deliver high-quality outputs. This may eliminate the need for resource-intensive monolithic architectures while retaining precision and relevance.

Moreover, the analysis techniques may provide deep contextual insights. Current systems often use embeddings to find relationships, but often fail to detect subtle dependencies or connections between entities, especially in complicated, interrelated data. Hypothetical alternatives may attempt to expand embedding-based similarity scoring, but would likely struggle to integrate relational and semantic insights effectively. In contrast, the disclosed analysis techniques may leverage a graph-based architecture to derive both explicit and implicit relationships between entities. This may provide nuanced insights that go beyond simple embedding-based retrieval.

Furthermore, the analysis techniques may provide real-time adaptability. Traditional systems typically require significant time to adapt to new queries or updated knowledge, often failing to respond dynamically in fast-changing environments. Potential alternatives may address adaptability by increasing retraining frequency or adding external rule-based techniques, but these approaches would lack flexibility and scalability. In contrast, the disclosed analysis techniques may dynamically adjust to new interactions, queries, and data updates in real time, thereby helping to ensure its responses remain contextually relevant.

The disclosed analysis techniques use initial schema definitions and dynamically populate a graph database. Moreover, the computer system may dynamically define its schema, make assumptions and groom data autonomously, thereby significantly reducing setup time. In some embodiments, the computer system may process documents, data structures, databases and other ingestible sources of information to generate the graph database. Furthermore, the distributed agents, adaptive content windows and dynamic graph database in the analysis techniques may provide flexibility and scalability across different domains. The resulting complexity may be abstracted for the end user, who may interact with the computer system (e.g., via a plug-in) without needing to understand its internal components. Note that the distributed nature of the computer system may spread workloads across smaller compute units, thereby minimizing bottlenecks and optimizing efficiency.

The analysis techniques may provide a foundational innovation that redefines the use of AI and LLMs (and, more generally, pretrained neural networks) across a vast range of applications and industries. Its unique ability to adapt, evolve, and operate autonomously while maintaining coherence and scalability may make it a transformative tool for an arbitrary domain requiring intelligent, context-aware systems. Moreover, the analysis techniques may facilitate knowledge management and intelligent retrieval.

The computer system may serve as an advanced knowledge engine capable of organizing, retrieving, and maintaining vast, complicated datasets with unparalleled efficiency. By integrating an adaptive graph database and context management, it may provide real-time retrieval of relevant information and the dynamic integration of new knowledge. Applications of the analysis techniques may include: enterprise knowledge systems (e.g., centralizing and contextualizing organizational policies, procedures, and documentation for streamlined workflows); legal and regulatory research (e.g., supporting legal professionals by retrieving relevant case law, statutes, and contextual precedence, while maintaining a record of prior research paths); and/or healthcare data systems (e.g., assisting healthcare providers by organizing and retrieving patient data, treatment plans, and/or research, while preserving long-term coherence across sessions).

Moreover, the analysis techniques may provide adaptive learning and personalized education. Notably, the analysis techniques may provide a robust framework for adaptive learning systems by dynamically tailoring content to individual users, tracking their progress, and/or offering contextual insights. This capability may enable: personalized learning platforms (e.g., customizing educational materials and pacing based at least in part on a learner's strengths, weaknesses, and/or progress); dynamic tutoring (e.g., by acting as an intelligent tutor capable of adapting to a student's specific needs, answering questions with accuracy, and/or maintaining long-term learning paths); and/or content expansion (e.g., by seamlessly integrating new materials, courses, or topics without requiring manual updates or interventions).

Furthermore, the analysis techniques may provide intelligent programming and code assistance. Notably, as a programming assistant, the computer system may enable developers to work more efficiently by providing targeted, relevant documentation and/or guidance. This may include: code documentation retrieval (e.g., fetching and summarizing functions and/or libraries); error debugging and resolution (e.g., by diagnosing and resolving errors by referencing relevant code snippets, patterns, or troubleshooting operations); and/or code integration guidance (e.g., offering context-aware suggestions for integrating multiple libraries, optimizing workflows, and/or creating efficient solutions).

Additionally, the analysis techniques may provide customer service and support automation. Notably, the analysis techniques may be used to provide: a dynamic back-end for customer service platforms, thereby enabling contextually relevant, personalized, and/or efficient interactions; multi-turn conversations (e.g., by retaining and using an interaction history to provide consistent and personalized support across multiple sessions); FAQ automation (e.g., by dynamically retrieving and summarizing policy, product, or service information based at least in part on user queries or input vectors); and/or issue resolution (e.g., handling complicated queries by synthesizing data from multiple sources to offer comprehensive solutions).

Note that the analysis techniques may provide real-time decision support systems. Notably, the real-time adaptability and ability to derive insights from interconnected data make the computer system a powerful tool for decision-making in dynamic environments, such as: healthcare (e.g., recommending treatments, diagnosing conditions, or summarizing medical research based at least in part on patient data and evolving knowledge bases); financial analysis (e.g., assisting in investment decisions by analyzing market trends, retrieving contextual financial data, and/or predicting outcomes); and/or disaster management (e.g., responding to crises by synthesizing large volumes of incoming data and/or providing actionable recommendations to decision-makers).

Moreover, the analysis techniques may provide storytelling, gaming, and/or content generation. Notably, the analysis techniques may enable dynamic, adaptive storytelling and gaming by leveraging its long-term memory and contextual understanding. This may include: interactive storytelling (e.g., generating narratives that evolve based at least in part on user choices while maintaining coherence and consistency in character and plot development); gaming engines (e.g., supporting non-player character or NPC interactions, dynamic quest generation, and/or immersive world-building); and/or generative writing tools (e.g., assisting authors or content creators by suggesting coherent plotlines, dialogue, or thematic structures).

Furthermore, the analysis techniques may provide research and development tools. Notably, the analysis techniques may enhance research workflows by dynamically retrieving, summarizing, and/or contextualizing relevant research materials. This may include: scientific research (e.g., by assisting researchers in exploring interconnected studies, synthesizing findings, and/or tracking historical research paths); and/or technology development (e.g., guiding engineers and developers by offering tailored recommendations on design approaches, frameworks, and/or best practices).

In some embodiments, the analysis techniques may provide domain-specific optimization. For example, the computer system may be tailored for specific industries or domains by customizing the graph-database schema, relevance filtering techniques, and LLM or pretrained neural network integration. Examples may include: healthcare optimization (such as redefined schemas for medical conditions, treatments, and/or research, thereby enabling faster and more accurate retrieval); and/or legal applications (e.g., structuring case law, statutes, and/or arguments for easier reference and long-term tracking).

The analysis techniques may provide multi-language and multimodal support. Notably, the analysis techniques may integrate multimodal data sources (such as images, audio, and video), thereby expanding its applications into fields requiring visual or auditory analysis. This may include: visual diagnosis in medicine (e.g., combining patient records with image recognition to enhance diagnostic precision); and/or video-based learning systems (e.g., summarizing video lectures and linking them to supplementary text-based materials).

Note that the analysis techniques may provide scalable deployment models. For example, the computer system may operate in a variety of deployment configurations to meet specific use cases, such as: cloud-based deployments (e.g., for global scalability and access across large organizations); edge or on-premises deployments (e.g., for industries requiring strict data security, such as government or healthcare); and/or hybrid models (e.g., combining local and cloud systems to optimize performance and resource management).

The analysis techniques may be integrated with existing AI systems. Notably, the analysis techniques may act as a plug-in or program module (or a set of instructions) for existing AI tools and frameworks, thereby extending their functionality without requiring a complete overhaul. This may include: customer relationship management or CRM (e.g., enhancing CRMs by adding real-time contextual memory and insights); and/or code development platforms (e.g., integrating with integrated development environments to provide programming guidance and error correction tools). In some embodiments, the analysis techniques may facilitate augmented collaboration. Notably, the computer system may support collaborative workflows by tracking and contextualizing team inputs and discussions; may facilitate shared knowledge spaces (e.g., by maintaining a collective knowledge graph for teams working on shared projects); and/or may provide a live annotation system (e.g., by dynamically annotating documents or discussions to provide real-time context and relevant links).

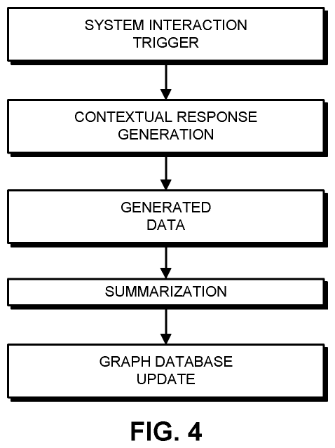

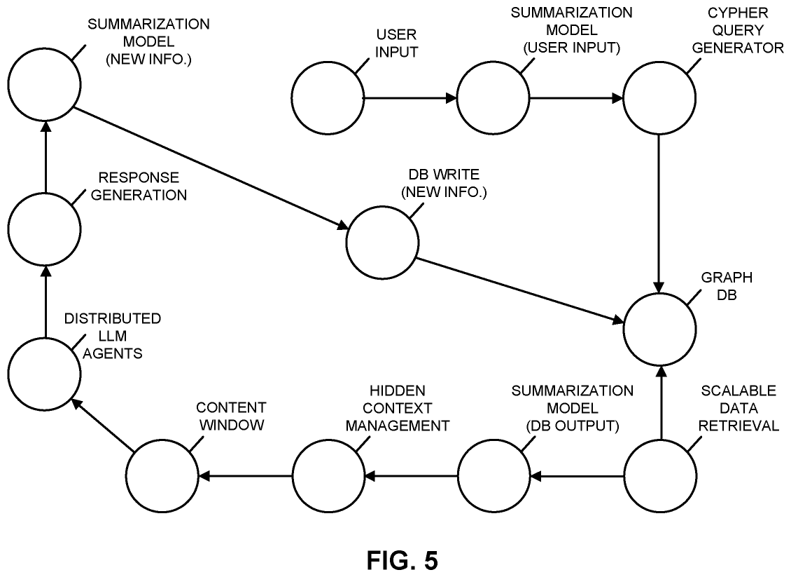

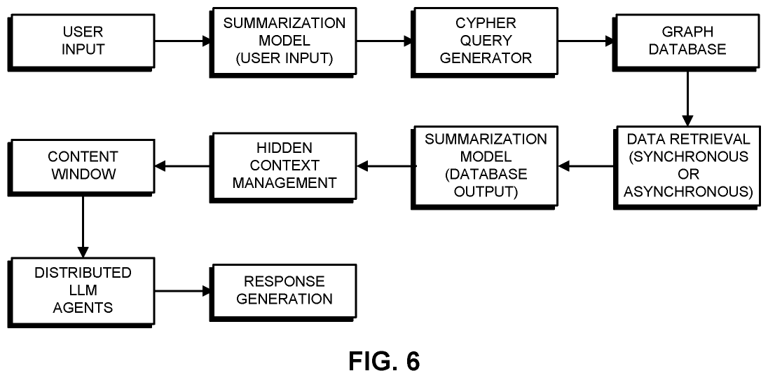

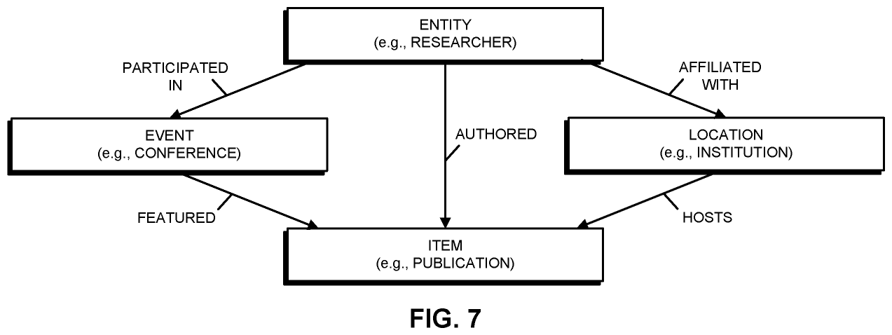

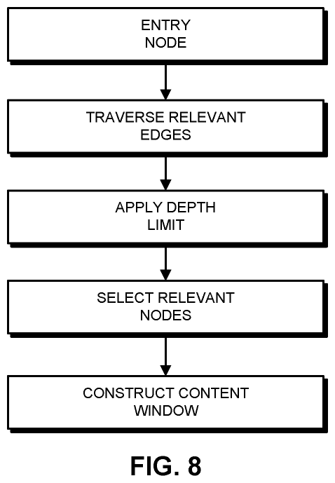

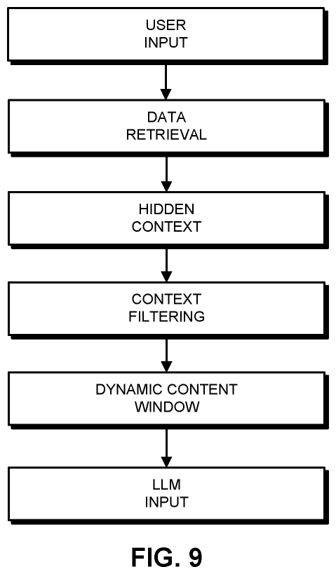

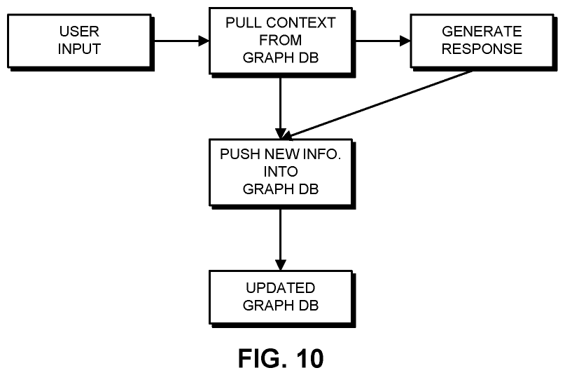

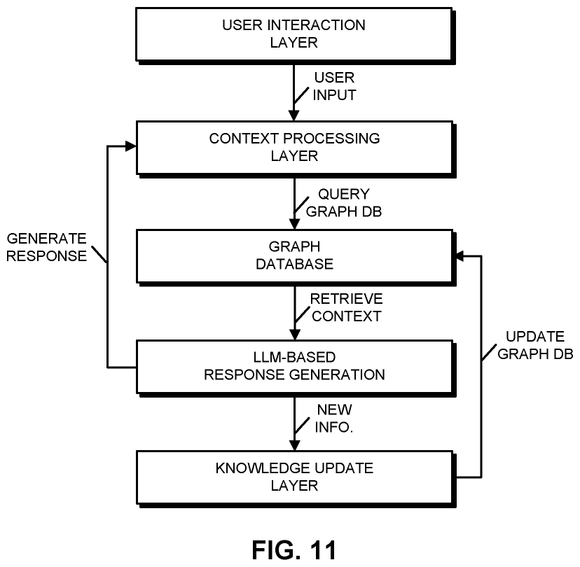

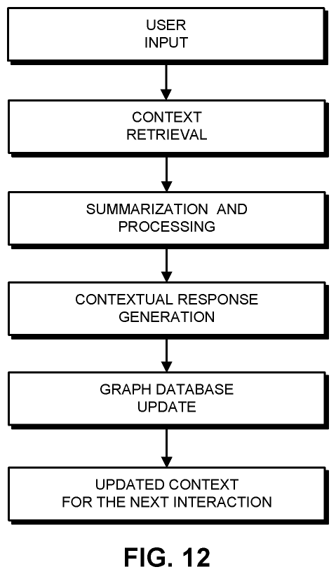

We now provide some drawings illustrating embodiments of the analysis techniques. FIG. 4 presents a flow chart illustrating contextual response generation and knowledge accumulation in accordance with an embodiment of the present disclosure. Moreover, FIG. 5 presents a block diagram illustrating a dynamic context system that uses a graph database (DB) in accordance with an embodiment of the present disclosure. FIG. 6 presents a flow chart illustrating data retrieval and content window construction in accordance with an embodiment of the present disclosure. Furthermore, FIG. 7 presents a drawing illustrating connections between different types of entities in accordance with an embodiment of the present disclosure. FIG. 8 presents a flow chart illustrating context node crawling in accordance with an embodiment of the present disclosure. Additionally, FIG. 9 presents a flow chart illustrating adaptive content windows in accordance with an embodiment of the present disclosure. FIG. 10 presents a drawing illustrating a push-pull graph system workflow in accordance with an embodiment of the present disclosure. Note that FIG. 11 presents a block diagram illustrating a system architecture in accordance with an embodiment of the present disclosure. FIG. 12 presents a flow chart illustrating a workflow for adaptive use cases.

The computer system that implements some or all of the analysis techniques may include one or more interdependent components that function seamlessly to provide context management, data retrieval, and/or real-time adaptability. Below is a detailed description of at least some of these components. In general, there may be fewer or additional components. For example, two components may be combined into a single component, and/or a single component may be divided into two or more components. In general, a given component may be implemented in hardware and/or software.

The adaptive graph database may provide the core knowledge repository, storing entities, relationships, and/or contextual information in a graph structure. It may enable real-time updates, retrieval, and/or dynamic schema definition. The graph database may include: nodes that represent entities (e.g., concepts, objects, events, etc.); edges that represent relationships between nodes, often weighted or annotated with additional metadata (e.g., ‘is related to,’ or ‘has property’); schema adaptability (e.g., the database structure may dynamically evolve based at least in part on the data ingested or new knowledge learned); and/or interaction (which may supply context to the hidden content window during query processing, and/or may update dynamically, e.g., via the push technique after interactions).

Moreover, the visible content window may represent the user-facing component of the computer system, and may contain the query and response exchanged between the user and the computer system. The visible content window may be designed for clarity and relevance, and may show only the interaction information needed by the user. During interaction, the visible content window may directly interface with the user. It may serve as the entry point for queries and the end point for delivering responses.

Furthermore, the hidden content window may act as the internal processing layer for the computer system, and may contain filtered data retrieved from the adaptive graph database that is relevant to the user's query. The hidden content window may be dynamically populated with information retrieved via contextual node crawling. It may maintain coherence across interactions without overloading the pretrained neural network. During operation, the hidden content window may supply contextual data to the pretrained neural network during response generation. It may be updated dynamically with each new query and response cycle.

Additionally, the push-and-pull graph system may manage the flow of information between the graph database and the computer system. It may help ensure that new knowledge is consistently integrated and relevant data is efficiently retrieved. The push technique may add newly generated or learned information to the graph database, and the pull technique may retrieve relevant data from the graph database for use in the hidden content window. This interaction may enable real-time knowledge updates and seamless integration of new information.

Note that the query processing component may refine and expand user queries into structured database queries, thereby ensuring precise data retrieval. The query processing component may provide: entity recognition (e.g., identifying key entities and relationships in the user query); and/or query transformation (e.g., translating the user's input into optimized queries for the graph database). During interaction, the query processing component may bridge the user's input with the graph database, thereby ensuring relevant and accurate information retrieval.

Moreover, the relevance filtering system may evaluate and prioritize (e.g., rank) data retrieved from the graph database to ensure only the most-relevant information is included in the hidden content window. For example, techniques may score nodes and edges based at least in part on proximity to the query and contextual importance. The relevance filtering system may filter out irrelevant or redundant data, and/or may prioritize contextually important nodes and edges based at least in part on the user query (or input vector). During interaction, the relevance filtering system may: work closely with the graph database to refine query results; and/or supply only meaningful data to the pretrained neural network.

Furthermore, the pretrained neural network (such as an LLM) may generate user-facing responses based at least in part on the combined or synthesizing information from the visible content window (such as the user query or input vector) and hidden content window (e.g., retrieved data). The pretrained neural network may: process natural language inputs or queries and generate coherent, contextually accurate outputs or responses; and/or function as the primary communication layer for the user-facing interaction. During interaction, the pretrained neural network may combine visible and/or hidden context to generate coherent, contextually relevant responses. Note that the pretrained neural network may output the response into the visible content window for the user. In general, the pretrained neural network may be an arbitrary front-facing pretrained neural network that is integrated with the computer system.

Additionally, the summarization model may condense raw data retrieved from the graph database into concise, digestible content for the hidden content window. It may extract key points, simplify complicated information while preserving key insights, and/or format data for efficient processing (such as by reducing the amount of data to be processed by downstream components). During interaction, the summation model may process raw outputs from the graph database to ensure that only pertinent information is passed to the hidden content window.

Moreover, the distributed agent system may handle parallel processing of tasks, such as query parsing, data retrieval, and/or summarization. It may divide computational tasks across smaller, specialized agents to optimize efficiency. During interaction, the distributed agent system may collaborate to process user queries, manage the graph database (such as retrieval), and/or generate responses. The agents may: operate asynchronously to manage tasks such as parsing, filtering, and summarization; and support scalability by distributing workloads across multiple agents.

Furthermore, the dynamic knowledge integration component may manage the ability of the computer system to learn and evolve by incorporating new knowledge into the graph database in real time during interactions. It may: analyze user interactions to identify new entities, relationships, or updates; and/or automate schema adjustments, node creation and/or relationship definitions to accommodate evolving data. During interaction, the distributed agent system may help ensure that the graph database remains up-to-date and relevant for future queries (e.g., by comparing and resolving new data against existing knowledge to maintain consistency).

During operation of the computer system, a user may interact with the computer system through the visible content window to submit a query, thereby initiating an interaction. Then, the query may be processed by the query processing component, which may identify key entities and relationships, and transform the query into a structured database request. Moreover, the pull technique may retrieve relevant nodes and edges from the adaptive graph database via contextual node crawling. The retrieved data may be filtered and summarized by the relevance filtering system and summarization model. Next, the filtered and summarized data may be stored in the hidden content window, where it supports response generation. Furthermore, the pretrained neural network (such as an LLM) may combine the visible and hidden contexts to craft a coherent and accurate response, which may be delivered back to the user in the visible content window. Additionally, new information or insights generated during the interaction may be processed by the dynamic knowledge integration component and pushed into the graph database via the push technique, thereby helping to ensure that the system evolves dynamically.

In the disclosed analysis techniques, the dynamic context management may introduce adaptive content windows, separating user-facing visible context from system-facing hidden context. The hidden context may be dynamically constructed based at least in part on the relevance of retrieved data, thereby optimizing memory usage and maintaining coherence. This approach may resolve the LLM content window limitation by offloading non-critical data to the hidden context, thereby allowing for efficient handling of long-term interactions.

Moreover, the adaptive graph database may transform a traditional graph databases into an adaptive system that dynamically defines its schema and evolves in real time. It may incorporate techniques for: dynamic knowledge integration (such as adding new nodes, edges, and/or attributes based on user interactions); and/or contextual node crawling (which may efficiently traversing the database to retrieve only the most-relevant data). This approach may eliminate the need for manual schema creation and updates, thereby enabling seamless adaptation to any domain or dataset.

Furthermore, the push-and-pull knowledge management may establish a dual technique for managing knowledge: push may automatically integrate new knowledge into the graph database during and after interactions; and pull may dynamically retrieve contextually relevant information for active queries. Unlike static or retraining-based systems, this approach may ensure real-time knowledge evolution without requiring external intervention.

Additionally, relevance filtering and summarization may introduce advanced techniques for relevance filtering, scoring nodes and edges based at least in part on query importance, and/or summarization, condensing retrieved data into usable forms. This operation may help ensure the hidden content window contains only the most-pertinent information, reducing computational overhead and/or improving response quality.

Note that the distributed language model agents may implement a network of smaller, specialized language model agents that collaborate on tasks such as query parsing, data retrieval, and/or response generation. The distributed agent design may improve scalability and fault tolerance, thereby reducing the reliance on monolithic pretrained neural network (such as LLM) architectures.

Moreover, freeform data ingestion may enable the computer system to initialize its graph database by ingesting and processing freeform documents, databases, and/or text sources. It may use a variant of the pretrained neural network to identify entity types, relationships, and/or schema structures autonomously. This capability may allow the computer system to adapt to any domain without requiring preexisting, structured datasets or manual input.

Furthermore, the computer system may be designed to dynamically adjust to user queries, context changes, and/or newly introduced data in real time. This approach may overcome the static nature of traditional AI systems by integrating adaptability directly into the architecture of the computer system, thereby helping to ensure constant relevance.

Additionally, the use of modularity and plug-and-play design may abstract the complexity of the graph database, distributed systems, and/or pretrained neural network integration, thereby allowing the analysis techniques to operate as a plug-in for AI systems. This approach may allow users to implement the analysis techniques without requiring expertise in the underlying components, thereby reducing the barrier to adoption.

In summary, the analysis techniques may integrate and significantly enhance existing technologies to create a cohesive, adaptive system. By addressing the limitations of static memory models, rigid graph databases, and non-dynamic architectures, it may provide a scalable, real-time AI solution capable of transforming interactions across industries.

We now describe context determination in the analysis techniques. The computer system may employ an advanced graph-based AI-driven system for dynamically retrieving and assembling contextual information. By leveraging a graph database (such as a vectorized graph database), the computer system may ensure accurate, real-time context determination for a given user query. The discussion that follows describes embodiments of how the computer system: crawls through graph nodes to extract relevant information; determines the relevancy of selected objects; and/or pulls relevant properties related to the original query.

In order to facilitate graph traversal for contextual retrieval, the computer system may store knowledge as a graph database, where entities (concepts, people, places, events, etc.) are represented as nodes, and relationships between them are defined as edges. Nodes in the graph may be vectorized, adding additional context capabilities that enhance retrieval and comparison.

When a query is received, the computer system may identifies the user's moving node. Notably, the user may have a ‘moving’ node that is dynamically attached to relevant pieces of information. This moving node may allow for adaptive traversal of the knowledge graph, thereby enabling context-sensitive retrieval.

Then, the computer system may expand the search via node crawling and vectorization. Notably, the computer system may dynamically determine the traversal depth based at least in part on query complexity. The traversal depth may expand outward by following linked nodes, thereby ensuring the most-contextually relevant entities are retrieved. Note that the computer system may use vectorization techniques to compare nearby nodes and refine retrieval based at least in part on semantic similarity.

Moreover, using adaptive depth control, the computer system may ensure the search remains efficient by iteratively expanding or constraining node retrieval. When too much information is retrieved, a relevance filtering technique may prune less significant nodes.

Next, the computer system may perform relevance determination of selected objects. Notably, once nodes are retrieved, the computer system may apply relevance filtering and vectorization to rank their significance. Note that graph-based relevance metrics may include: a node centrality score (which may determine how connected a node is within the network); a contextual similarity score (which may measure how often a node appears in queries with similar intent); and/or recency weighting (which may hives preference to nodes with recent interactions or modifications). Moreover, vector-based context matching may use vector embeddings to compare semantic similarity between the query and retrieved nodes. Entities with high cosine similarity to the query context may be retained, while lower-ranked entities may be discarded. Furthermore, crawling may be performed for additional context. For example, even when vectorization is not performed, the computer system may check and traverse linked nodes. This may help ensure comprehensive retrieval of related entities and a deeper understanding of the data.

Furthermore, the computer system may perform property extraction for a query response. Notably, once the most-relevant nodes have been selected, the computer system may extract and synthesize data. This may include: the retrieval of relevant properties; summarization and contextual condensation; and/or integration with a user context. In the retrieval of relevant properties: only the key attributes (e.g., descriptions, timestamps, relationships, etc.) needed to answer the query may be retrieved; and/or AI-driven agents may be used to determine the most-relevant properties, and recursively summarizing them until a final condensed summary is formed. This approach may enable a scalable summarization system, where queries of increasing complexity may trigger a swarm of summarization agents that can refine responses dynamically. Moreover, in the summarization and contextual condensation, information from multiple nodes may be condensed using AI-driven summarization. This may help ensure concise, yet complete responses, thereby avoiding information overload. Note that the computer system may scale infinitely, using as few as one summarization operation or dynamically expanding based at least in part on query complexity. In the integration with a user context, newly retrieved information may be pushed back into the knowledge store, thereby allowing for continuous learning. When required, new nodes and edges may be dynamically added to enhance future query accuracy.

In some embodiments, the computer system may use a push-and-pull graph technique. Notably, the computer system may maintain real-time updates to the graph database using a push-and-pull technique. The pull technique may retrieve data dynamically based at least in part on user queries and/or existing knowledge. Moreover, the push technique may store newly generated insights into the graph for future reference, thereby ensuring that the context is continuously enriched.

By integrating graph-based retrieval, AI-driven query adaptation, and/or dynamic context filtering, the computer system may efficiently determine the most-relevant and useful context for an arbitrary given query or input vector. The scalable, self-adaptive knowledge system may allow for high-precision responses while continuously evolving based at least in part on user interactions.

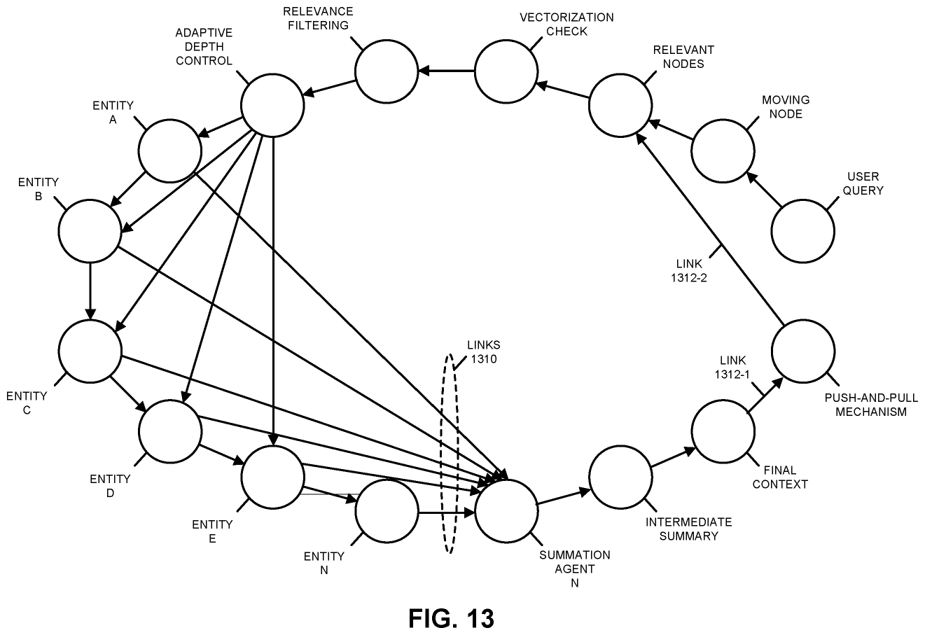

FIG. 13 presents a drawing illustrating retrieving, evaluating, and refining of contextual knowledge at scale in a generalized graph network in accordance with an embodiment of the present disclosure. By leveraging adaptive depth control, scalable AI summarization, and/or a knowledge-enhancing push-and-pull technique, the computer system may deliver precise and dynamically evolving context for any given query. Notably, FIG. 13 illustrates how the computer system dynamically retrieves, evaluates, and/or refines contextual information using an adaptive, AI-driven process. The workflow may follow a circular structure, emphasizing how context is generated, filtered, summarized, and/or integrated back into the computer system for continuous updates.

This process may include user query initiation. Notably, a user query may be received, which may trigger the moving node to attach to relevant knowledge graph data.

Then, in relevant node retrieval and processing, the moving node may pull in relevant nodes from the vectorized graph database. A vectorization check may ensure semantic similarity between the query and retrieved nodes. Moreover, relevance filtering may rank the retrieved nodes based at least in part on node centrality, recency weighting, and/or contextual similarity.

Moreover, in adaptive depth control, the computer system may dynamically expand or limit traversal to avoid unnecessary data retrieval. Note that entities A, B, C, D, E, up to variable N may be identified for further processing.

Next, in summarization processing, a summarization agent N may receive relevant entities via links 1310, indicating a scalable summarization process. The summarization agents may recursively process and condense retrieved information. The result may be structured into an intermediate summary before finalizing.

Furthermore, in final context generation, the refined context may be consolidated into the final context. Using the push-and-pull graph technique, the final context may be integrated back into the graph database for future queries when new information is found. Notably, a given one of links 1312 from the push-and-pull graph technique to the relevant nodes may demonstrate how new knowledge can continuously enhance retrieval and filtering processes.

Note that the summarization agent N may allow for infinite scalability and dynamic adapting to query complexity. Moreover, vectorization and relevance filtering may ensure that only the most-important nodes are selected, thereby optimizing context retrieval and preventing unnecessary data retrieval. Furthermore, adaptive depth control may help ensure efficiency by expanding or limiting retrieval depth. Additionally, the computer system may use recursive summarization for clarity. Data may be processed in multiple summarization stages, thereby ensuring a concise yet comprehensive response. Note that, in continuous knowledge enhancement, the push-and-pull graph technique may ensure that newly generated insights refine future queries, thereby making the computer system continuously smarter over time.

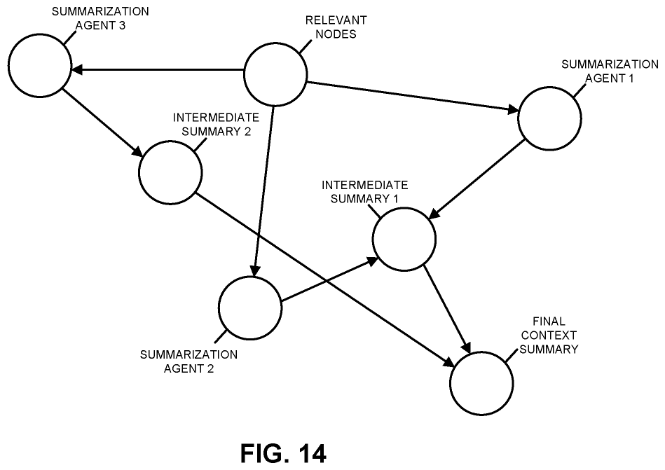

FIG. 14 presents a drawing illustrating swarm-based summation in accordance with an embodiment of the present disclosure. This swarm agent summarization diagram illustrates how the computer system scales summarization dynamically using a swarm of AI agents to refine and condense retrieved information.

This process may include retrieval of relevant nodes the knowledge graph. Summarization agent N may represent a scalable number of AI agents that process and refine information. These agents may work in parallel, breaking down data into intermediate summaries as needed. The computer system may recursively condense the summaries until a final context summary is formed.

Note that this approach may be: scalable (e.g., the number of agents may adjust based at least in part on query complexity); efficient (e.g., data may be summarized in layers, thereby preventing overload); and/or adaptive (e.g., the computer system may continuously optimize responses in real time). FIG. 14 highlights how the computer system may efficiently process complicated queries by leveraging a swarm-based AI summarization approach.

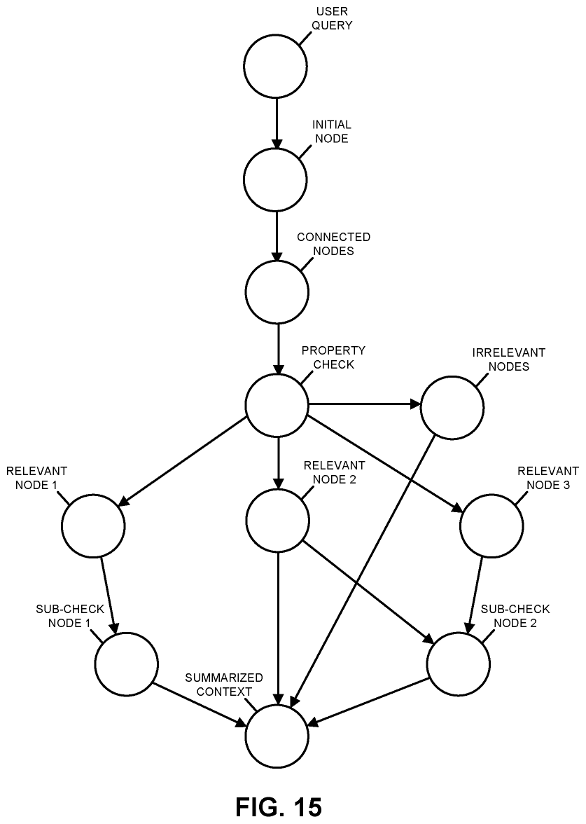

FIG. 15 presents a drawing illustrating the building of relevant and summarized context in accordance with an embodiment of the present disclosure. This organized node crawling Diagram illustrates how the computer system systematically traverses, evaluates, and filters nodes to build a relevant and summarized context from a user's query.

This process may include: a user query initiation (e.g., the computer system may start with the moving the initial node that holds user information); connected nodes discovery (e.g., the computer system may retrieve related nodes sharing direct edges from the knowledge graph); a property check (e.g., each connected node may be evaluated for relevance); relevant nodes continue to be processed (e.g., irrelevant nodes may be discarded from summarized context, but included in a node crawl); recursive crawling (e.g., when a relevant node has additional meaningful connections, those may be further explored in a so-called sub-check nodes operation); and/or summarization and context integration (where relevant properties from the crawled nodes may be synthesized into a final summarized context).

In FIG. 15, the computer system may perform hierarchical node crawling in which the search expands outward, while prioritizing only relevant information. Moreover, the computer system may perform recursive relevance filtering, e.g., node properties may be assessed with a pretrained neural network, thereby automating context generation. Furthermore, the computer system may provide efficient summarization. Notably, the process may dynamically integrate meaningful properties, while discarding unnecessary data.

We now describe different examples of the interaction between a user and the computer system while using the analysis techniques. Table 1 provides an example of the analysis techniques and, in particular, the interaction between a user and the computer system in response to a litigation-related query from the user. Moreover, Table 2 provides an example of generative software coding. Table 3 provides an example of a personalized campaign. Furthermore, Table 4 provides an example of adaptive medical records and recommendations. Table 5 provides an example of proactive issue resolution. Additionally, Table 6 provides an example of workflow automation. Table 7 provides an example of business strategy. Note that Table 8 provides an example of a token count with multi-operation storytelling. Tables 9 and 10 provide additional examples of interaction between a user and the computer system while using the analysis techniques.

TABLE 1

Operation 1: User Input
User Input: “Find cases where self-defense was used as an argument in civil liability claims.”
User Input Summarized: “Retrieve past legal cases involving self-defense in civil liability
claims.”
Operation 2: Named Entity Recognition (NER)
Entities Identified:
[Self-Defense] -> Legal Principle
[Civil Liability] -> Case Category
[Cases] -> Document Retrieval Type
Operation 3: Query Formulation and Execution
Generated Cypher Query:
MATCH (c:Case)-[:INVOLVES]->(d:Doctrine { name: “Self-Defense”})
WHERE c.category = “Civil Liability”
RETURN c.case_name, c.jurisdiction, c.year, c.outcome
LIMIT 10;
Operation 4: Database Search & Node Crawl
Node Crawl:
[Self-Defense Doctrine] -> [Linked Civil Liability Cases]
├ Case: “Doe v. Smith” (2020, CA)-Outcome: Defense Won
├ Case: “Johnson v. State” (2018, TX)-Outcome: Defense Lost
├ Case: “Anderson v. Blake” (2015, NY)-Outcome: Defense Won
Results from Database Summarized:
1. Doe v. Smith (2020, CA) - Defense Won
2. Johnson v. State (2018, TX) - Defense Lost
3. Anderson v. Blake (2015, NY) - Defense Won
Operation 5: Summarization and Context Storage
Summary from Database Added to Hidden Context:
[Hidden Context]:
- Self-defense case law retrieved (3 cases).
- 2 out of 3 cases ruled in favor of the defense.
Operation 6: Query Sent to LLM for Analysis
Hidden Context and Summarized User Query Sent to LLM:
User Query: “Find cases where self-defense was used as an argument in civil liability
claims.”
Context Provided:
- Doe v. Smith (2020, CA)-Defense Won
- Johnson v. State (2018, TX) - Defense Lost
- Anderson v. Blake (2015, NY) - Defense Won
LLM Responds with Relevant Answer:
“Self-defense has been successfully used in civil liability claims in 2 out of 3 cases retrieved.
In Doe v. Smith (2020, CA) and Anderson v. Blake (2015, NY), the defense successfully
argued that force was justified. However, in Johnson v. State (2018, TX), the court ruled
against the defense, emphasizing excessive force.”
Operation 7: LLM-Generated Information Stored Back in Database
New Information from LLM is Summarized:
[Doe v. Smith] -> [Key Ruling: Self-defense justified]
[Anderson v. Blake] -> [Key Ruling: Self-defense upheld]
[Johnson v. State] -> [Key Ruling: Excessive force led to loss]
New Information Written to Database:
MATCH (c:Case {case_name: “Doe v. Smith”})
SET c.key_ruling = “Self-defense justified”;
MATCH (c:Case {case_name: “Anderson v. Blake”})
SET c.key_ruling = “Self-defense upheld”;
MATCH (c:Case {case_name: “Johnson v. State”})
SET c.key_ruling = “Excessive force led to loss”;

TABLE 2

```
Operation 1: User Input
User Input: “Generate a Python function that fetches data from an API using requests and
adheres to internal logging standards.”
User Input Summarized: “Create a Python function for API data retrieval using requests with
integrated logging.”
Operation 2: Named Entity Recognition (NER)
Entities Identified:
[Python] -> Programming Language
[Function] -> Code Structure
[API] -> Concept (External Service Communication)
[Requests] -> Library Dependency
[Logging Standards] -> Internal Best Practices
Operation 3: Query Formulation and Execution
Generated Cypher Query:
MATCH (1:Library {name: “requests”})-[:HAS_VERSION]->(v: Version)
WHERE v.latest = true
WITH l, v
MATCH (s:Standard {name: “Logging”})-[:APPLIES_TO]->(c:CodeGuideline)
RETURN l.name, v.version, s.name, c.rule_text
Operation 4: Database Search & Node Crawl
Node Crawl:
[Requests Library] -> [Latest Version]
├ Version: “2.32.3”
[Logging Standards] -> [Internal Code Guidelines]
├ Rule: “Use structured JSON logs with timestamps.”
├ Rule: “Ensure all errors are logged at ERROR level.”
Results from Database Summarized:
1. Latest version of requests: 2.32.3
2. Logging requirements:
  - Structured JSON logs with timestamps
  - Errors logged at ERROR level
Operation 5: Summarization & Context Storage
Summary from Database Added to Hidden Context:
[Hidden Context]:
- Requests version 2.32.3 should be used
- Logging must be structured in JSON with timestamps
- Errors must be logged at ERROR level
Operation 6: Query Sent to LLM for Code Generation
Hidden Context and Summarized User Query Sent to LLM:
User Query: “Generate a Python function that fetches data from an API using requests and
adheres to internal logging standards.”
Context Provided:
- Use requests 2.32.3 for API calls
- Implement structured JSON logs with timestamps
- Ensure errors are logged at ERROR level
LLM Responds with Relevant Code:
′′′
import requests
import json
import logging
logging.basicConfig(level=logging.INFO, format=‘%(asctime)s - %(levelname)s - %
(message)s’)
def fetch_api_data(url):
    “““Fetches data from an API while adhering to internal logging standards.”””
    try:
      response = requests.get(url)
      response.raise_for_status( )
      data = response.json( )
      logging.info(json.dumps({“event”: “API Request Successful”, “url”: url, “status”:
response.status_code}))
      return data
    except requests.exceptions.RequestException as e:
        logging.error(json.dumps({“event”: “API Request Failed”, “url”: url, “error”: str(e)}))
        return None
′′′
Operation 7: LLM-Generated Code Stored Back in Database
New Information from LLM is Summarized:
[Function fetch_api_data] -> [Uses requests 2.32.3]
[Logging] -> [JSON format with timestamps]
[Error Handling] -> [RequestsException captured]
New Information Written to Database:
MATCH (f:Function {name: “fetch_api_data”})
SET f.uses_library = “requests 2.32.3”,
  f.logging_standard = “JSON format with timestamps”,
  f.error_handling = “RequestsException captured”;
```

TABLE 3

```
Operation 1: User Input
User Input: “Generate a personalized email campaign for a customer who recently browsed
running shoes and follows marathon events.”
User Input Summarized: “Create a dynamic email campaign for a user interested in running
shoes and marathon events.”
Operation 2: Named Entity Recognition (NER)
Entities Identified:
[Personalized Email Campaign] -> Marketing Strategy
[Customer] -> Individual Profile
[Running Shoes] -> Product Category
[Marathon Events] -> Interest Category
Operation 3: Query Formulation and Execution
Generated Cypher Query:
MATCH (c:Customer)-[:INTERESTED_IN]->(p:ProductCategory {name: “Running
Shoes”})
MATCH (c)-[:ENGAGES_WITH]->(e:EventCategory {name: “Marathon Events”})
WITH c
MATCH (r:Recommendation)-[:RELEVANT_TO]->(p)
RETURN c.name, p.name, e.name, r.product, r.message
Operation 4: Database Search & Node Crawl
Node Crawl:
[Customer] -> [Running Shoes Interest]
├ Browsing History: “Nike Air Zoom Pegasus, Adidas Ultraboost”
[Customer] -> [Marathon Events Engagement]
├ Followed: “Boston Marathon, NYC Marathon”
[Product Recommendations] -> [Based on Interests]
├ Nike Air Zoom Pegasus - “Optimized for marathon runners”
├ Adidas Ultraboost - “Designed for long-distance comfort”
Results from Database Summarized:
1. Customer recently browsed Nike Air Zoom Pegasus and Adidas Ultraboost
2. Customer follows Boston Marathon and NYC Marathon
3. Recommended products: Nike Air Zoom Pegasus, Adidas Ultraboost
4. Suggested messaging:
  - “Optimized for marathon runners”
  - “Designed for long-distance comfort”
Operation 5: Summarization & Context Storage
Summary from Database Added to Hidden Context:
[Hidden Context]:
- Customer interested in running shoes (Nike Air Zoom Pegasus, Adidas Ultraboost)
- Follows major marathon events (Boston, NYC)
- Suggested messaging based on product fit for marathons
Operation 6: Query Sent to LLM for Personalized Campaign Creation
Hidden Context and Summarized User Query Sent to LLM:
User Query: “Generate a personalized email campaign for a customer who recently browsed
running shoes and follows marathon events.”
Context Provided:
- Customer browsed Nike Air Zoom Pegasus, Adidas Ultraboost
- Follows Boston Marathon, NYC Marathon
- Recommended messaging based on marathon-focused shoe benefits
LLM Responds with Relevant Personalized Email:
′′′
Subject: Take Your Runs to the Next Level!
Hi [Customer's Name],
We noticed you're gearing up for marathon season! Whether you're training for the Boston
Marathon or setting your sights on NYC, the right gear can make all the difference.
[running emoji] Nike Air Zoom Pegasus-Engineered for marathon performance, delivering
energy return with every stride.
[running emoji] Adidas Ultraboost-Designed for maximum comfort over long distances,
helping you push further.
As a valued runner, we're offering 10% off your next purchase to help you hit the pavement
with confidence.
Claim your exclusive offer now → [Shop Now]
See you at the finish line!
The [Brand Name] Team
′′′
Operation 7: LLM-Generated Content Stored Back in Database
New Information from LLM is Summarized:
[Campaign] -> [Nike Air Zoom Pegasus, Adidas Ultraboost Promotion]
[Personalization] -> [Mentions Customer's Interest in Marathon Events]
[Offer] -> [10% Discount]
New Information Written to Database:
MATCH (c:Campaign {name: “Marathon Runner Email”})
SET c.target_products = [“Nike Air Zoom Pegasus”, “Adidas Ultraboost”],
  c.personalization = “Mentions Marathon Interest”,
  c.discount_offer = “10%”;
```

TABLE 4

```
Operation 1: User Input
User Input: “Recommend a treatment plan for a patient diagnosed with Stage II lung cancer
who has a history of hypertension and is allergic to cisplatin.”
User Input Summarized: “Generate a personalized treatment recommendation for a Stage II
lung cancer patient with hypertension and cisplatin allergy.”
Operation 2: Named Entity Recognition (NER)
Entities Identified:
[Patient] -> Individual Medical Profile
[Stage II Lung Cancer] -> Diagnosis
[Hypertension] -> Comorbidity
[Cisplatin Allergy] -> Medication Sensitivity
[Treatment Plan] -> Medical Recommendation
Operation 3: Query Formulation and Execution
Generated Cypher Query:
MATCH (p:Patient)-[:DIAGNOSED_WITH]->(d:Disease {name: “Stage II Lung Cancer”})
MATCH (p)-[:HAS_CONDITION]->(c:Comorbidity {name: “Hypertension”})
MATCH (p)-[:ALLERGIC_TO]->(m:Medication {name: “Cisplatin”})
WITH p
MATCH (t:Treatment)-[:RECOMMENDED_FOR]->(d)
WHERE NOT (t)-[:CONTAINS]->(m)
RETURN p.name, d.name, c.name, t.name, t.success_rate, t.research_link
Operation 4: Database Search & Node Crawl
Node Crawl:
[Patient] -> [Diagnosis: Stage II Lung Cancer]
├ Comorbidity: Hypertension
├ Allergy: Cisplatin
[Stage II Lung Cancer] -> [Available Treatments]
├ Chemotherapy: “Cisplatin + Pemetrexed” (Not Recommended-Contains Cisplatin)
├ Targeted Therapy: “Osimertinib” (Recommended-Effective in EGFR-positive cases)
├ Immunotherapy: “Pembrolizumab” (Recommended-Effective for PD-L1 expression
>50%)
Results from Database Summarized:
1. Patient has Stage II lung cancer with hypertension and a cisplatin allergy.
2. Cisplatin-based chemotherapy should be avoided.
3. Recommended treatments:
  - Osimertinib (Effective for EGFR-positive lung cancer)
  - Pembrolizumab (Effective if PD-L1 expression >50%)
Operation 5: Summarization & Context Storage
Summary from Database Added to Hidden Context:
[Hidden Context]:
- Patient diagnosed with Stage II lung cancer.
- Comorbidity: Hypertension.
- Allergy: Cisplatin (avoid cisplatin-based chemotherapy).
- Alternative treatments: Osimertinib (EGFR-positive) and Pembrolizumab (PD-L1 >50%).
Operation 6: Query Sent to LLM for Personalized Treatment Recommendation
Hidden Context and Summarized User Query Sent to LLM:
User Query: “Recommend a treatment plan for a patient diagnosed with Stage II lung cancer
who has a history of hypertension and is allergic to cisplatin.”
Context Provided:
- Diagnosis: Stage II lung cancer
- Comorbidity: Hypertension
- Allergy: Cisplatin
- Alternative treatments: Osimertinib (EGFR-positive) and Pembrolizumab (PD-L1 >50%)
LLM Responds with Relevant Treatment Recommendation:
“Given the patient's diagnosis of Stage II lung cancer, history of hypertension, and allergy to
cisplatin, it is recommended to avoid standard platinum-based chemotherapy. Instead,
molecular testing should be conducted to determine if the patient is EGFR-positive or has
high PD-L1 expression.
1. Osimertinib: If the patient has an EGFR mutation, Osimertinib is a preferred targeted
therapy with high efficacy and manageable side effects.
2. Pembrolizumab: If PD-L1 expression is greater than 50%, Pembrolizumab is a
recommended first-line immunotherapy option.
3. Alternative Chemotherapy Regimen: A non-platinum-based chemotherapy such as
Paclitaxel combined with Bevacizumab may be considered if neither of the above options is
viable.”
Operation 7: LLM-Generated Information Stored Back in Database
New Information from LLM is Summarized:
[Stage II Lung Cancer] -> [Recommended Treatment: Osimertinib (EGFR+), Pembrolizumab
(PD-L1 >50%)]
[Patient] -> [Requires Molecular Testing for EGFR and PD-L1]
[Alternative Treatment] -> [Paclitaxel + Bevacizumab (Non-Platinum Chemotherapy)]
New Information Written to Database:
MATCH (d:Disease {name: “Stage II Lung Cancer”})
SET d.recommended_treatments = [“Osimertinib (EGFR+)”, “Pembrolizumab (PD-L1
>50%)”, “Paclitaxel + Bevacizumab”];
MATCH (p:Patient {name: “Patient X”})
SET p.requires_testing = [“EGFR Mutation Test”, “PD-L1 Expression Test”];
```

TABLE 5

```
Operation 1: User Input
User Input: “Identify potential service disruptions for customers experiencing slow internet
speeds and provide a proactive resolution.”
User Input Summarized: “Detect slow internet service issues and recommend proactive
resolutions.”
Operation 2: Named Entity Recognition (NER)
Entities Identified:
[Customer] -> Service Subscriber
[Internet Speed] -> Service Metric
[Service Disruptions] -> Issue Type
[Resolution] -> Recommended Action
Operation 3: Query Formulation and Execution
Generated Cypher Query:
MATCH (c:Customer)-[:HAS_SERVICE]->(s:Service {type: “Internet”})
MATCH (c)-[:REPORTED_ISSUE]->(i:Issue {type: “Slow Speed”})
WITH c, s, i
MATCH (n:NetworkNode)-[:AFFECTS]->(s)
WHERE n.status = “Degraded”
RETURN c.name, s.plan, i.type, n.location, n.status, n.estimated_fix_time
Operation 4: Database Search & Node Crawl
Node Crawl:
[Customer] -> [Service: Internet]
├ Plan: “Fiber 500 Mbps”
├ Reported Issue: Slow Speed
[Network Node] -> [Degraded Performance]
├ Location: “New York City-Central Hub”
├ Estimated Fix Time: “2 hours”
Results from Database Summarized:
1. Customers with Fiber 500 Mbps plans in NYC are experiencing slow speeds.
2. Root cause identified: Network degradation at central hub.
3. Estimated resolution time: 2 hours.
Operation 5: Summarization & Context Storage
Summary from Database Added to Hidden Context:
[Hidden Context]:
- Customers in NYC with Fiber 500 Mbps plans are affected by slow speeds.
- Issue traced to degraded network performance at the central hub.
- Estimated fix time: 2 hours.
Operation 6: Query Sent to LLM for Proactive Customer Notification
Hidden Context and Summarized User Query Sent to LLM:
User Query: “Identify potential service disruptions for customers experiencing slow internet
speeds and provide a proactive resolution.”
Context Provided:
- Customers with Fiber 500 Mbps plans in NYC report slow speeds.
- Network degradation detected at central hub.
- Estimated resolution time: 2 hours.
LLM Responds with Relevant Customer Notification:
“Dear Customer,
We've detected a temporary slowdown in your internet service due to network congestion at
our central hub in NYC. Our engineers are actively working on resolving the issue, and we
expect full service restoration within the next 2 hours.
In the meantime, you can try these operations for a smoother experience:
1. Restart your modem and router to refresh your connection.
2. Use a wired connection for critical activities.
3. Limit high-bandwidth usage during peak hours.
We appreciate your patience and are committed to keeping you connected.
Thank you,
[Telecom Provider] Support Team”
Operation 7: LLM-Generated Information Stored Back in Database
New Information from LLM is Summarized:
[Service Issue] -> [Degraded Network Performance - NYC]
[Affected Customers] -> [Fiber 500 Mbps Plan Subscribers]
[Resolution] -> [Fix in 2 Hours, Temporary Workarounds Suggested]
New Information Written to Database:
MATCH (i:Issue {type: “Slow Speed”, location: “New York City”})
SET i.estimated_resolution_time = “2 hours”,
  i.customer_notification_sent = true,
  i.recommended_actions = [“Restart modem”, “Use wired connection”, “Limit high-
bandwidth usage”];
```

TABLE 6

```
Operation 1: User Input
User Input: “Automate IT ticket management by prioritizing and resolving issues based on
real-time updates and historical patterns.”
User Input Summarized: “Optimize IT ticket processing using real-time updates and past
resolution data.”
Operation 2: Named Entity Recognition (NER)
Entities Identified:
[IT Ticket] -> Support Request
[Issue Priority] -> Severity Classification
[Real-Time Updates] -> Dynamic Status Monitoring
[Historical Patterns] -> Data-Driven Decision Making
Operation 3: Query Formulation and Execution
Generated Cypher Query:
MATCH (t: Ticket)-[:HAS_CATEGORY]->(c:IssueType)
MATCH (t)-[:ASSIGNED_TO]->(g:SupportGroup)
MATCH (t)-[:HAS_PRIORITY]->(p:PriorityLevel)
WITH t, c, g, p
MATCH (h:HistoricalResolution)-[:RESOLVED_ISSUE]->(c)
WHERE h.success_rate > 80
RETURN t.id, c.name, g.name, p.level, h.average_resolution_time, h.best_practice_solution
Operation 4: Database Search & Node Crawl
Node Crawl:
[Open IT Tickets] -> [Issue Categories]
├ Ticket ID: #15234
| ├ Category: “Network Outage”
| ├ Assigned Group: “Network Support Team”
| ├ Priority: High
[Historical Data] -> [Resolution Patterns]
├ Issue: “Network Outage”
| ├ Average Resolution Time: 3 hours
| ├ Best Practice Solution: “Restart affected routers, reconfigure load balancer”
Results from Database Summarized:
1. Open IT tickets classified by category and priority.
2. Network Support Team assigned to high-priority network outage issues.
3. Historical resolutions indicate a 3-hour average resolution time for similar outages.
4. Recommended best practice: Restart routers, reconfigure load balancer.
Operation 5: Summarization & Context Storage
Summary from Database Added to Hidden Context:
[Hidden Context]:
- IT Ticket #15234: High-priority network outage assigned to Network Support Team.
- Historical resolution data: Similar issues resolved in 3 hours using predefined operations.
- Suggested workflow: Automate ticket escalation and apply recommended solution.
Operation 6: Query Sent to LLM for Workflow Automation Recommendation
Hidden Context and Summarized User Query Sent to LLM:
User Query: “Automate IT ticket management by prioritizing and resolving issues based on
real-time updates and historical patterns.”
Context Provided:
- High-priority network outage assigned to Network Support Team.
- Past resolution data suggests a 3-hour fix time.
- Recommended actions: Restart routers, reconfigure load balancer.
LLM Responds with Optimized Workflow Automation:
“To enhance IT ticket resolution, the following automation operations can be applied:
1. Immediate Ticket Escalation: Because this is a high-priority network outage, notify the
Network Support Team via email and internal chat.
2. Automated Initial Resolution: Execute a pre-configured network diagnostic script to
identify failing nodes and attempt a remote router restart.
3. Dynamic Workflow Adjustment: If the automated restart fails, escalate the issue to a Level
2 technician and notify affected users with an estimated resolution time.
4. Historical Best Practices Applied: Reconfigure the load balancer if network bottlenecks are
detected.
Estimated time to resolution: 3 hours based on past cases.”
Operation 7: LLM-Generated Workflow Updates Stored Back in Database
New Information from LLM is Summarized:
[IT Ticket #15234] -> [Priority: High, Assigned: Network Support Team]
[Automation Operations] -> [Immediate Escalation, Network Diagnostics, Remote Restart,
Load Balancer Reconfiguration]
[Estimated Resolution Time] -> [3 Hours]
New Information Written to Database:
MATCH (t: Ticket {id: 15234})
SET t.automation_operations = [“Immediate Escalation”, “Network Diagnostics”, “Remote
Restart”, “Load Balancer Reconfiguration”],
  t.estimated_resolution_time = “3 hours”,
  t.status = “In Progress-Automated”;
```

TABLE 7

```
Operation 1: User Input
User Input: “What is the best approach to increase revenue next quarter given our current
budget constraints and strategic objectives?”
User Input Summarized: “Analyze revenue growth strategies based on budget constraints and
strategic goals.”
Operation 2: Named Entity Recognition (NER)
Entities Identified:
[Revenue Growth] -> Business Objective
[Budget Constraints] -> Financial Limitation
[Strategic Objectives] -> Company Goals
[Next Quarter] -> Timeframe
Operation 3: Query Formulation and Execution
Generated Cypher Queries:
Query for Budget Information:
MATCH (b:Budget)-[:APPLIES_TO]->(q:Quarter {name: “Q2 2024”})
RETURN b.total_allocation, b.remaining_funds, b.spending_limits
Query for Strategic Objectives:
MATCH (s:Strategy)-[:FOR_TIMEFRAME]->(q:Quarter {name: “Q2 2024”})
RETURN s.goal, s.key_initiatives
Query for Revenue Trends:
MATCH (r:Revenue)-[:RECORDED_IN]->(p:PastQuarter)
WHERE p.year >= 2023
RETURN r.quarter, r.total_revenue, r.growth_rate
Operation 4: Database Search & Node Crawl
[Budget Documents] -> [Current Quarter Budget]
├ Total Allocation: $5,000,000
├ Remaining Funds: $1,200,000
├ Spending Limits: “Max $500,000 per initiative”
[Strategic Objectives] -> [Current Business Goals]
├ Goal: “Expand digital advertising presence“
├ Key Initiatives: “Invest in targeted social media campaigns, Improve SEO, Partner with
influencers”
[Revenue Trends] -> [Past Growth Performance]
├ Q1 2023 Revenue: $10,000,000 (+5% growth)
├ Q2 2023 Revenue: $10,500,000 (+4% growth)
├ Q3 2023 Revenue: $11,000,000 (+4.8% growth)
├ Q4 2023 Revenue: $11,300,000 (+2.7% growth)
Results from Database Summarized:
1. Budget available: $1,200,000 with a $500,000 per initiative limit.
2. Strategic focus: Digital advertising expansion via social media, SEO, and influencers.
3. Past revenue trends indicate slowing growth (from 5% in Q1 2023 to 2.7% in Q4 2023).
Operation 5: Summarization & Context Storage
Summary from Database Added to Hidden Context:
[Hidden Context]:
- Budget constraints: $1,200,000 remaining, $500,000 cap per initiative.
- Strategic focus: Increase digital ad presence through targeted campaigns.
- Revenue growth has slowed in recent quarters, requiring higher-impact strategies.
Operation 6: Query Sent to LLM for Strategic Recommendation
Hidden Context and Summarized User Query Sent to LLM:
User Query: “What is the best approach to increase revenue next quarter given our current
budget constraints and strategic objectives?”
Context Provided:
- Budget: $1,200,000 remaining, $500,000 per initiative.
- Strategic focus: Expand digital presence via social media, SEO, influencers.
- Revenue growth slowing (5% to 2.7% over past four quarters).
LLM Responds with Recommended Business Strategy:
“Given your available budget and strategic focus, I recommend the following revenue-
boosting initiatives:
1. Targeted Social Media Ads ($500,000)
  - Focus on high-engagement platforms (Instagram, TikTok).
  - Utilize retargeting ads to convert past visitors.
  - Estimated ROI: 10-15% increase in Q2 revenue.
2. SEO Optimization & Content Strategy ($400,000)
  - Invest in AI-generated SEO-optimized content.
  - Improve page load speeds and mobile optimization.
  - Estimated ROI: 7-10% increase in organic traffic.
3. Influencer Partnerships ($300,000)
  - Partner with micro-influencers in key demographics.
  - Focus on product placement and long-term ambassador deals.
  - Estimated ROI: 8-12% increase in brand engagement.
Projected revenue growth: 7-10% in Q2 2024.”
Operation 7: LLM-Generated Strategy Stored Back in Database
New Information from LLM is Summarized:
[Q2 2024 Strategy] -> [Digital Ad Expansion, SEO Growth, Influencer Partnerships]
[Budget Allocation] -> [$500K Social Ads, $400K SEO, $300K Influencers]
[Projected Revenue Growth] -> [7-10%]
New Information Written to Database:
MATCH (q:Quarter {name: “Q2 2024”})
SET q.recommended_initiatives = [“Social Ads ($500K)”, “SEO Optimization ($400K)”,
“Influencer Partnerships ($300K)”],
  q.projected_growth = “7-10%”;
```

TABLE 8

Operation 1: User Input
User Input: “I walk into the tavern and look around. What do I see?”
User Input Summarized: “User enters the tavern and observes surroundings.”
Operation 2: Named Entity Recognition (NER)
Entities Identified:
[User] -> Player Character
[Tavern] -> Location
[Observing Surroundings] -> Action
Operation 3: Query Formulation and Execution
Generated Cypher Query:
MATCH (t:Tavern)-[:HAS_OCCUPANTS]->(p:Patron)
MATCH (t)-[:HAS_DETAILS]->(d:Description)
RETURN t.name, d.ambiance, p.count, p.mood
Operation 4: Database Search & Node Crawl
[Tavern] -> [Environment Details]
├ Name: “The Rusty Mug”
├ Ambiance: “Dimly lit, smell of ale, chatter of patrons”
[Tavern] -> [Patrons Present]
├ Number of Patrons: 6
├ Mood: Relaxed, casual conversation
Results from Database Summarized:
1. User is inside “The Rusty Mug.”
2. The tavern is dimly lit, smells of ale, and has a lively but relaxed crowd.
3. Six patrons are scattered around, chatting casually.
Operation 5: Summarization & Context Storage
Summary from Database Added to Model Prompt:
[Model Prompt]:
- System Instructions: Role-playing mechanics, world consistency rules, narrative style
guidance.
- User Preferences: Interaction style, previous world knowledge, recurring NPC references.
- World State: Major locations, characters, unresolved quests, known historical events.
- Immediate Context: User enters “The Rusty Mug,” which is dimly lit, smells of ale, and has
six patrons engaged in casual conversation.
Hidden Context and Summarized User Query Sent to LLM
LLM Responds:
“The tavern is dimly lit, filled with the scent of aged ale. A few groups of patrons are
scattered at wooden tables, engaged in quiet conversation. The bartender wipes a mug behind
the bar, occasionally glancing at new arrivals.”
Operation 6: New Information Written to Database
[Tavern] -> [Observed Details: “Bartender behind the bar, patrons at tables.”]
- Estimated Token Count this Turn
- Current Turn Window: approximately 250 tokens
- Model Prompt: approximately 4,000 tokens
- CM Processed Tokens: approximately 4,250 tokens
- Standard LLM Context: approximately 4,250 tokens

TABLE 9

Operation 1: User Input
User Input: “I ask the bartender if he's heard of any missing persons lately.”
User Input Summarized: “User inquires about missing persons.”
Operation 2: Named Entity Recognition (NER)
Entities Identified:
[User] -> Player Character
[Bartender] -> NPC
[Missing Persons] -> Investigation Topic
Operation 3: Query Formulation and Execution
Generated Cypher Query:
MATCH (t:Tavern)-[:HAS_OCCUPANT]->(b:Bartender)
MATCH (m:MissingPerson)-[:MENTIONED_IN]->(t)
RETURN b.name, m.case_details
Operation 4: Database Search & Node Crawl
[Tavern] -> [Bartender Information]
├ Name: “Garret”
[Missing Persons Cases] -> [Linked to Tavern]
├ Case: “Young man named Ral missing, last seen at the tavern two nights ago.”
Results from Database Summarized:
1. Bartender Garret serves at “The Rusty Mug.”
2. Garret recalls a missing person case—Ral, last seen two nights ago.
Operation 5: Summarization & Context Storage
Summary from Database Added to Model Prompt:
[Model Prompt]:
- System Instructions: Narrative coherence, dynamic response handling, memory constraints.
- User Preferences: Persistent investigative approach, preferred pacing.
- World State: Active storylines, NPC reputations, regional conflicts, player decisions.
- Immediate Context: User inquires about missing persons, bartender Garret recalls Ral
missing two nights ago.
Hidden Context and Summarized User Query Sent to LLM
LLM Responds:
“Garret sets down the mug he was cleaning and narrows his eyes. ‘Ral? Yeah, he was here a
couple nights ago. Seemed nervous. Left in a hurry, didn't say where he was going.’”
Operation 6: New Information Written to Database
[Missing Persons Case] -> [Ral Last Seen: “Two nights ago, left in a hurry.”]
- Estimated Token Count this Turn
- Current Turn Window: approximately 400 tokens
- Model Prompt: approximately 4,000 tokens
- CM Processed Tokens: approximately 4,400 tokens
- Standard LLM Context: approximately 53,500 tokens

TABLE 10

Operation 1: User Input
User Input: “I've tracked Ral to an abandoned mill outside town. Does anything seem off
about this place?”
User Input Summarized: “User examines abandoned mill for suspicious activity.”
Operation 2: Named Entity Recognition (NER)
Entities Identified:
[User] -> Player Character
[Abandoned Mill] -> Location
[Examining] -> Action
Operation 3: Query Formulation and Execution
Generated Cypher Query:
MATCH (m:Mill)-[:HAS_FEATURE]->(f:Observation)
MATCH (m)-[:HAS_HISTORY]->(h:Event)
RETURN f.details, h.recent_activity
Operation 4: Database Search & Node Crawl
[Abandoned Mill] -> [Environmental Details]
├ Exterior: “Old wooden structure, broken windows, vines growing on the walls.”
[Recent Activity] -> [Unusual Sightings]
├ “Torchlight seen inside last night.”
├ “Footprints in the mud leading to the entrance.”
Results from Database Summarized:
1. The abandoned mill is in disrepair-broken windows, vines, aged wood.
2. Last night, torchlight was spotted inside.
3. Fresh footprints indicate recent activity.
Operation 5: Summarization & Context Storage
Summary from Database Added to Model Prompt:
[Model Prompt]:
- System Instructions: Maintain narrative continuity, prioritize key details, enforce logical
consequences.
- User Preferences: Strong focus on investigation, detailed environmental descriptions.
- World State: Prior locations visited, NPC interactions, open investigations.
- Immediate Context: User examines abandoned mill, which shows signs of recent activity—
torchlight and fresh footprints.
Hidden Context and Summarized User Query Sent to LLM
LLM Responds:
“As you approach the abandoned mill, the old wooden boards creak under your weight. The
place looks deserted, but the faint smell of burning wood lingers in the air. Through the
broken windows, you catch a glimpse of movement—someone is inside.”
Operation 6: New Information Written to Database
[Abandoned Mill] -> [Suspicious Observations: “Faint smell of burning wood, movement
inside.”]
- Estimated Token Count this Turn
- Current Turn Window: approximately 500 tokens
- Model Prompt: approximately 4,000 tokens
- CM Processed Tokens: approximately 4,500 tokens
- Standard LLM Context: approximately 503,500 tokens

Regarding the content window efficiency in these examples, note that for each turn the computer system may retain only the necessary contextual details, thereby avoiding loss of coherence. The model prompt from the LLM (approximately 4,000 tokens) may ensure static reference knowledge, thereby keeping world mechanics, story structure, and persistent elements in memory. Moreover, the total token processing may remain stable (approximately 4,000 plus the current turn) rather than growing exponentially, thereby ensuring cost-effective and efficient usage. Furthermore, existing or standard LLM Context models may be computationally prohibitive at the scales shown, while the computer system maintains real-time adaptation while preserving accuracy and efficiency.

We now provide some definitions used in the present discussion. An ‘adaptive content window’ may include two distinct processing layers used by the computer system to manage user interaction. The visible content window may contain the immediate interaction content presented to the user. The hidden content window may include contextually relevant data retrieved from the knowledge database to generate responses. This layer may be dynamically adjusted based at least in part on query complexity and relevance.

Moreover, in the present discussion, a ‘graph database’ may include a database system that represents entities (nodes) and their relationships (edges) in a graph structure. In this invention, the graph database may be adaptive and dynamically update its schema, nodes, and edges in real time, enabling efficient storage and retrieval of interconnected data.

Furthermore, in the present discussion, ‘contextual node crawling’ may include a process of traversing nodes and edges within the graph database to retrieve the most-relevant information. Nodes and edges may be prioritized based at least in part on relevance scoring, which may evaluate their importance to the current query or context.

Additionally, in the present discussion, ‘relevance filtering’ may include techniques used to evaluate and prioritize retrieved data based at least in part on its importance to the user's query. Irrelevant or redundant information may be excluded, thereby helping to ensure the language model processes only concise and meaningful data.

Note that, in the present discussion, a ‘push-and-pull graph system’ may include a push technique that provides a process by which new information generated during an interaction is analyzed, structured, and stored into the graph database, and a pull technique that provides a process of retrieving relevant data from the graph database for inclusion in the hidden content window during query processing.

Moreover, in the present discussion, ‘dynamic knowledge integration’ may include a process of continuously analyzing, summarizing, and incorporating new information into the graph database during and after interactions. This may ensure that the knowledge base evolves and remains up-to-date without manual intervention.

Furthermore, in the present discussion, ‘distributed language model agents’may include a set of smaller, specialized AI components working in parallel to handle distinct tasks (e.g., query parsing, summarization, and/or database interaction). These agents may collaborate to produce a coherent output without requiring a single monolithic language model.

Additionally, in the present discussion, ‘entity recognition and expansion’ may include a process by which the computer system identifies key entities (e.g., people, objects, and/or concepts) within a user query and expands their context by associating them with related entities, properties, and/or relationships in the graph database.

Note that, in the present discussion, a ‘summarization model’ may include a component of the computer system that condenses retrieved data into concise, readable formats suitable for inclusion in the hidden content window. This may help ensure that only relevant information is presented to the language model for response generation.

Moreover,, in the present discussion, ‘freeform data ingestion’ may include a process in which the computer system interprets and processes structured or unstructured input data (e.g., documents, databases, text files, etc.) to dynamically generate an initial knowledge graph. The computer system may use a pretrained neural network to identify entities, relationships, and/or properties from the ingested data.

Furthermore, in the present discussion, a ‘knowledge evolution loop’ may include a continuous cycle in which the computer system: retrieves and uses existing knowledge to respond to queries; identifies and integrates new knowledge from interactions; and/or updates the graph database to reflect the added information for future interactions.

Additionally, in the present discussion, a ‘hidden context’ may include contextual information retrieved from the graph database and used internally by the system to formulate responses. This data may not be visible to the user, but may serve as the basis for generating accurate and relevant output. Moreover, in the present discussion, a ‘visible context’ may include the direct content of the interaction that is presented to the user, such as their query and the response from the computer system and/or the pretrained neural network. This is distinct from the hidden context, which may operate behind the scenes.

Furthermore, in the present discussion, a ‘dynamic schema definition’ may include the ability of the computer system to autonomously define and adjust the structure of its graph database based at least in part on the data it ingests. This may include identifying new entity types, attributes, and/or relationships as required by the domain or input data.

Additionally, in the present discussion, ‘real-time adaptation’ may include the capability of the computer system to respond to new queries, incorporate new knowledge, and/or adjust its operations dynamically during active interactions. This may help ensure that the computer system remains relevant and responsive without requiring offline updates or retraining.

Note that, in the present discussion, a ‘query transformation’ may include the process of refining and expanding a user's query (or input vector) into a structured format suitable for database retrieval. This may include identifying implicit and explicit entities and generating optimized database queries.

Moreover, in the present discussion, a ‘plug-and-play system’ may include a design that allows for seamless integration into existing workflows or language model frameworks. The analysis techniques may function autonomously, requiring minimal configuration or expertise from the user to operate.

We now describe additional embodiments of the analysis techniques. Existing AI context management systems typically operate on explicit user input. However, these existing AI context management systems often lack awareness of the user's physical environment and surrounding context. This limitation may create gaps in practical applications.

For example, the existing AI context management systems may suffer from: environmental blindness (such as an inability to adapt their information retrieval based on the user's location, nearby entities, or situational context without explicit user commands); entity recognition disconnection (such as a failure to integrate facial recognition, object detection, and/or other recognition systems with knowledge retrieval systems that can provide meaningful context about recognized entities); multi-sensor integration challenges (such as an inability to unify data streams from diverse sensors, e.g., in autonomous systems and wearable devices, thereby frustrating the reconciliation and contextualizing of this information); contradiction handling deficiency (such as when multiple data sources or temporal statements conflict, it can be difficult to detect, flag, and/or appropriately handle the contradictory information); static context limitations (such as using fixed retrieval patterns regardless of environmental changes, which may require manual reconfiguration for different contexts); and/or difficulty scaling under environmental load (e.g., processing continuous environmental data streams while maintaining responsive knowledge retrieval may create computational challenges that existing architectures and systems may be unable to handle). These limitations may prevent deployment of context-aware AI in real-world environments where environmental awareness is essential for utility.

The analysis techniques include a dynamic AI context system that incorporates real-time environmental inputs from one or more sensors (which may include multi-modal sensors), thereby enabling context-aware information retrieval and presentation based at least in part on a user's physical environment, detected entities, and/or situational context. The dynamic AI context system may integrate external data sources (such as data from: facial recognition systems, geographic positioning or location systems, image recognition systems, audio processing systems, and/or another type of environmental sensor) to dynamically adjust a content window and retrieve relevant information from an adaptive knowledge store.

In some embodiments, the dynamic AI context system may include contradiction detection that identifies conflicting information across multiple data sources or temporal statements, thereby enabling real-time verification and anomaly flagging. This capability may apply across diverse implementations, including: conversational analysis, multi-sensor fusion for autonomous systems, and/or cross-referential data validation.

The dynamic AI context system may treat environmental inputs as contextual modifiers that influence hierarchical traversal, relevance filtering, and/or information retrieval without requiring application-specific architecture changes. This may enable deployment across diverse use cases, including: augmented reality systems, wearable devices, autonomous navigation, sales and networking applications, and/or situational awareness platforms.

Note that the dynamic AI context system may be implemented using an electronic device and/or a remotely located computer system. Thus, the dynamic AI context system may be implemented locally and/or remotely, in a centralized or a distributed manner. The dynamic AI context system may include: a sensor abstraction layer with unified input processing for one or more diverse types of sensors (e.g., visual, audio, geographic, proximity, etc.) that are feed into the dynamic AI context system; entity recognition and mapping to provide real-time identification of external entities and automatic association with stored knowledge representations; environmental context switching to provide dynamic adjustment of hierarchical traversal parameters based at least in part on geographic, temporal, and/or situational inputs; a contradiction detection engine that performs cross-referential analysis to identify conflicting information across sources, time periods, and/or sensor modalities; continuous context streaming that provides event-driven or periodic polling to maintain real-time environmental awareness; and/or selective relevance filtering to provide energy-efficient retrieval that remains highly performing and accurate regardless of the size of an underlying data set size using contextual filtering. These capabilities may enable environmentally aware AI applications to adapt their knowledge retrieval and presentation based at least in part on the user's real-world context, thereby supporting applications from personal assistance to autonomous system decision-making.

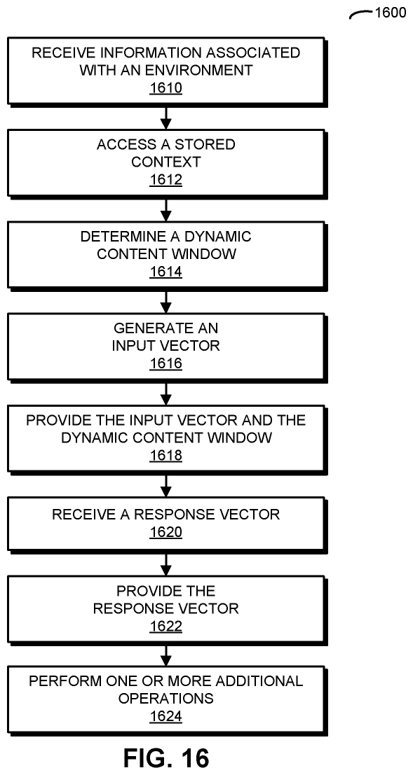

FIG. 16 is a flow diagram illustrating an example of a method 1600 for determining a dynamic content window, which may be performed by a computer system (such as computer system 100 in FIG. 1). During operation, the computer system may receive, from an electronic device, information associated with an environment of an electronic device (operation 1610). Then, the computer system may access a stored context corresponding to the information (operation 1612). Moreover, the computer system may determine a dynamic content window (operation 1614) based at least in part on the information and/or the context, where the dynamic content window has a length less than a predefined value. Next, the computer system may generate an input vector (operation 1616), which is sometimes referred to as a ‘prompt’ or a ‘query,’ based at least in part on the information, the context and the dynamic content window. Furthermore, the computer system may provide, to a pretrained neural network, the input vector and the dynamic content window (operation 1618). Additionally, the computer system may receive, from the pretrained neural network, a response vector (operation 1620), and may provide, addressed to the electronic device, the response vector (operation 1622).

Note that the context may be stored in a graph database (or data structure). For example, the graph database may include a vector graph database.

Moreover, the pretrained neural network may include an LLM. (However, the analysis techniques may be used with a wide variety of types of neural networks.)

Note that the predefined value may be less than or equal to 8,095 tokens. Alternatively or additionally, the predefined value may be significantly smaller than 128,000 tokens.

Moreover, the dynamic content window may correspond to a next or subsequent operation in an interaction between the electronic device and the pretrained neural network.

Furthermore, the pretrained neural network may be implemented using or hosted by a second computer system, where the second computer system is different from the computer system.

Additionally, the response vector may be based at least in part on the input vector and the dynamic content window.

In some embodiments, the pretrained neural network may include one or more convolutional layers, one or more residual layers and one or more dense layers. Note that a given node in a given layer in the pretrained neural network may include an activation function that includes: a ReLU, a leaky ReLU, an ELU activation function, a parametric ReLU, a tanh activation function, and/or a sigmoid activation function.

Moreover, the information may include: real-time data associated with the environment, facial recognition data, location data, image recognition data, audio, one or more images, object detection data, and/or another type of sensor data.

In some embodiments, the computer system optionally performs one or more additional operations (operation 1624). For example, the computer system may modify the dynamic content window based at least in part on the response vector.

Moreover, during operation, the computer system may update the context based at least in part on the information, the input vector and/or the response vector.

Furthermore, prior to accessing the context (operation 1612), the computer system may normalized the information.

Additionally, during operation, the computer system may update, in the graph database, the context based at least in part on the input vector and the response vector.

In some embodiments of method 1600, there may be additional or fewer operations. Furthermore, the order of the operations may be changed, and/or two or more operations may be combined into a single operation. Additionally, in some embodiments, method 1600 may exclude the determining of the dynamic content window (operation 1614).

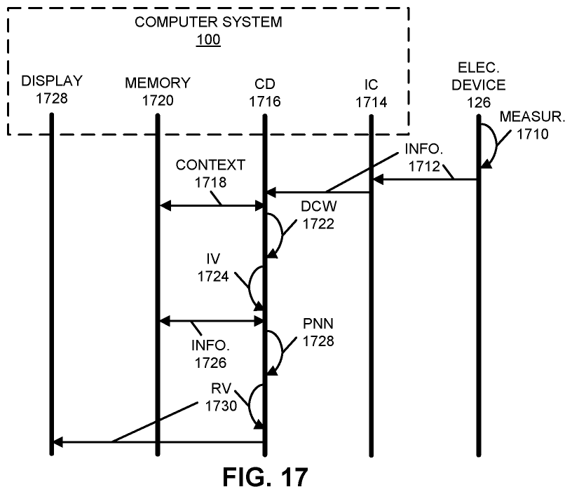

Embodiments of the analysis techniques are further illustrated in FIG. 17, which presents a drawing illustrating an example of communication between components in computer system 100. In FIG. 17, electronic device 126 may acquire or perform one or more measurements 1710 associated with an environment of electronic device 126, such as a region surrounding or proximate to electronic device 126. For example, electronic device 126 may acquire or take a picture or an image of an individual in the environment. More generally, the one or more measurements 1710 may include: real-time data associated with the environment, facial recognition data (e.g., of the individual), location data (such as cellular-telephone network data, data from a Global Positioning System or GPS, etc.), image recognition data, audio, one or more images (such as video), object detection data, and/or another type of sensor data. Then, electronic device 126 may provide information 1712 corresponding to or that specifies the one or more measurements 1710 to computer system 100.

After receiving information 1712, an interface circuit (IC) 1714 in computer system 100 may provide information 1712 to a computation device (CD) 1716 (such as a processor or a GPU) in computer system 100. Computation device 1716 may access stored context 1718 corresponding to information 1712. For example, context 1718 may be stored in memory 1720 in or associated with computer system 100. Notably, context 1718 may be stored in a graph database or data structure in memory 1720.

Moreover, computation device 1716 may determine a dynamic content window (DCW) 1722 based at least in part on information 1712 and/or context 1718, where the dynamic content window 1722 has a length less than a predefined value. Next, computation device 1716 may generate an input vector (IV) 1724 based at least in part on information 1712, context 1718 and the dynamic content window 1722.

In some embodiments, either before, concurrently or subsequent to at least some of the preceding operations, computation device 1716 may access, in memory 1720, information 1726 specifying configuration instructions and hyperparameters for a pretrained neural network (PNN) 1728. After receiving the configuration instructions and the hyperparameters, computation device 1716 may implement the pretrained neural network 1728. Alternatively or additionally, in other embodiments, the pretrained neural network 1728 may be implemented by another computer system (not shown).

Next, computation device 1716 may provide, to pretrained neural network 1728, input vector 1724 and the dynamic content window 1722. Furthermore, computation device 1716 may receive, from pretrained neural network 1728, a response vector 1730.

Additionally, computation device 1716 may provide an instruction 1732 to interface circuit 1714 to provide, addressed to electronic device 126, response vector (RV) 1730.

After receiving response vector 1730, electronic device 126 may present response vector 1730 to a user. For example, response vector 1730 may be displayed on a display 1732 in or associated with electronic device 126, output on a speaker, etc. More generally, response vector 1730 may be provided to the user using a human-interface device.

While FIG. 17 illustrates communication between components using unidirectional or bidirectional communication with lines having single arrows or double arrows, in general the communication in a given operation in this figure may involve unidirectional or bidirectional communication. Moreover, while FIG. 17 illustrates operations being performed sequentially or at different times, in other embodiments at least some of these operations may, at least in part, be performed concurrently or in parallel.

We now further describe embodiments of the analysis techniques. The dynamic AI context system may include a sensor abstraction layer that: processes environmental inputs, integrates them with existing user context, and/or translates the combined state into contextual parameters for an adaptive knowledge store (such as a pretrained neural network). The dynamic AI context system may be used with an arbitrary neural network architecture.

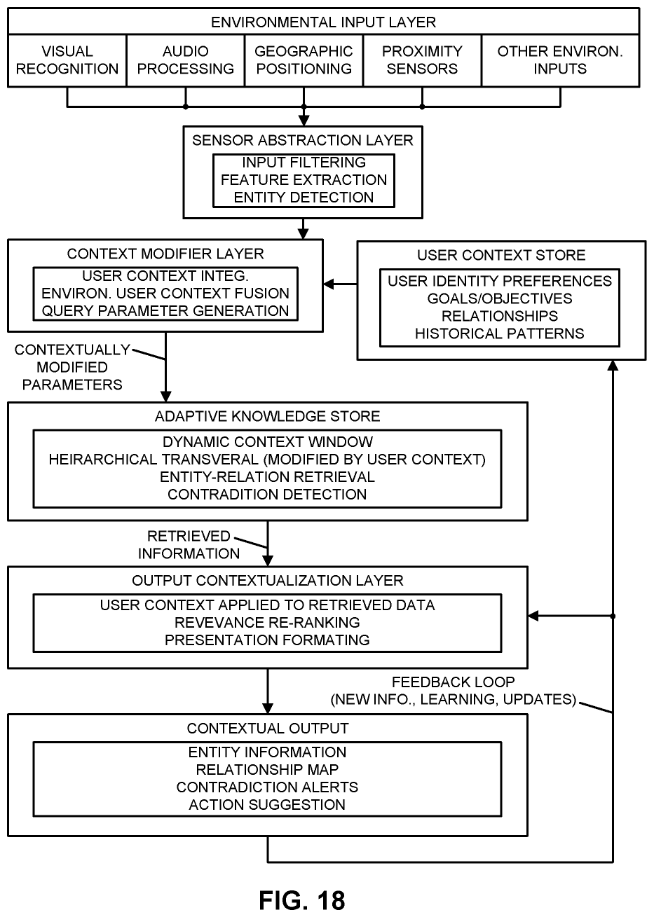

FIG. 18 presents a drawing illustrating an example of interactions among components in computer system 1800. In FIG. 18, an environmental input layer may receive data from an arbitrary type of sensor. Note that the architecture may be agnostic to the type of sensor and may support a wide variety of inputs that can be processed by a pretrained neural network or another recognition system. Moreover, in FIG. 18, a sensor abstraction layer may: filter out irrelevant inputs; extract meaningful features, and/or identifies a potential entity (such as an object, an individual, etc.). This layer may normalize diverse inputs into a standardized environmental state representation.

Furthermore, in FIG. 18, a context modifier layer may combine filtered environmental state with an existing user context. This layer may: retrieve a current user context from a user context store (such as a graph database or data structure); fuse environmental state with user identity, preferences, goals, and/or relationship information; generate contextually modified query parameters that reflect what is happening environmentally and who the user is and/or what they care about.

Additionally, in FIG. 18, a user context store may provide persistent storage of user-specific information that modifies system interactions. The user context store may include: user identity and recognition parameters; stated and inferred preferences; current goals and objectives; relationship mappings to one or more other entities; and/or historical interaction patterns and/or learned behaviors.

In some embodiments, in FIG. 18, an adaptive knowledge store may be a knowledge repository in which hierarchical traversal and retrieval are modified by the combined environmental and user context. Query parameters from the context modifier layer may determine: which hierarchical branches to traverse; what relevance weights to apply; which entity relationships to prioritize; and/or what contradiction comparisons to perform.

Note that, in FIG. 18, an output contextualization layer may process retrieved information through user context before presentation. For example, the processing may include: relevance re-ranking based at least in part on user goals; formatting appropriate to user preferences and a current situation; prioritizing information that is most actionable for the specific user.

Moreover, in FIG. 18, a feedback loop may flow new information generated during interaction (e.g., conversation content, user actions, environmental changes, etc.) back to update the user context store and/or the adaptive knowledge store, thereby enabling continuous learning and adaptation.

As noted previously, this architecture may be agnostic to the type of pretrained neural network with which it is used. Notably, the architecture may operate with an arbitrary neural network implementation, such as: a convolutional neural networks (e.g., for visual recognition, image processing, scene understanding, etc.); a recurrent neural networks (e.g., for audio processing, temporal pattern recognition, sequence analysis, etc.); a transformer architecture (e.g., for language processing, attention-based recognition, etc.); a hybrid architectures (such as a multi-modal fusion network); and/or a custom architectures (such as a domain-specific neural network implementation). Note that the sensor abstraction layer and/or the context modifier layer may provide standardized interfaces that accept output from an arbitrary type of neural network architecture and may translate this output into the contextual parameters used by the adaptive knowledge store.

In some embodiments, the analysis techniques may provide environmental context integration with an adaptive knowledge system. Notably, the analysis techniques may include or involve: receiving an input from one or more environmental sensor modalities processed by a pretrained neural network; normalizing sensor data through a unified abstraction layer into standardized contextual parameters; integrating filtered environmental state with stored user context to generate contextually modified query parameters; modifying knowledge retrieval parameters based at least in part on combined environmental and user context; retrieving information from an adaptive knowledge store using the contextually modified parameters’ and/or applying user context to retrieved information for relevance re-ranking and presentation formatting.

Alternatively or additionally, the analysis techniques may provide entity recognition and automatic knowledge association. Notably, the analysis techniques may include or involve: detecting entities through environmental sensor inputs processed by a pretrained neural network; encoding detected entity characteristics into comparable representations; matching encoded representations against knowledge store entity records; integrating matched entity information with user context to determine relationship relevance and a retrieval priority; retrieving relationship-aware contextual information for matched entities as modified by user context; monitoring entity presence and state changes for context updates; and/or updating a knowledge store with new entity information and relationship data.

Moreover, alternatively or additionally, the analysis techniques may provide contradiction detection. Notably, the analysis techniques may include or involve: receiving information from multiple sources including sensor inputs processed by a pretrained neural network, conversational data, and/or stored knowledge; performing cross-referential analysis to identify conflicting information across temporal statements, sensor modalities, and/or data sources; applying configurable tolerance thresholds appropriate to an application domain; generating contradiction alerts with provenance information for identified conflicts; supporting resolution strategies including escalation to additional data sources, user notification, and/or knowledge store update; and/or integrating contradiction detection results with user context for prioritized alerting based at least in part on user goals and relevance.

Furthermore, alternatively or additionally, the analysis techniques may provide environmental context switching. Notably, the analysis techniques may include or involve: detecting environmental state through one or more sensor inputs processed by a pretrained neural network; inferring contextual parameters from environmental data, including geographic, temporal, entity presence, and/or situational factors; combining inferred environmental context with stored user context to determine context switching parameters; dynamically adjusting knowledge retrieval parameters based at least in part on combined context; supporting multiple context modification strategies, including hierarchy switching, relevance weight adjustment, and/or distance-based filtering; and/or maintaining context switching without requiring explicit user commands.

In some embodiments, alternatively or additionally, the analysis techniques may provide continuous context streaming. Notably, the analysis techniques may include or involve: supporting event-driven updates triggered by environmental changes detected by a pretrained neural network; supporting periodic polling updates at configurable intervals; supporting hybrid combinations of event-driven and periodic techniques; integrating streaming updates with user context for relevance-based processing prioritization; optimizing efficiency through differential processing, hierarchical caching, and/or selective activation; and/or maintaining real-time environmental awareness with configurable update parameters.

Moreover, in some embodiments, alternatively or additionally, the analysis techniques may provide selective relevance filtering system for environmental inputs. Notably, the analysis techniques may include or involve: applying initial presence filters to discard clearly irrelevant inputs from neural network sensor processing; performing entity and context resolution for relevant inputs; integrating user context, including goals, preferences, and/or relationships, to calculate relevance scores; applying configurable relevance thresholds to limit retrieval scope; constraining knowledge store traversal to environmentally and user-relevant branches; and/or maintaining consistent performance regardless of total dataset size through contextual filtering.

Moreover, in some embodiments, alternatively or additionally, the analysis techniques may provide a sensor abstraction layer. Notably, the analysis techniques may include or involve: receiving processed output from diverse neural network systems, including visual recognition, audio processing, geographic positioning, proximity detection, and/or environmental sensors; extracting relevant features based at least in part on sensor type and neural network output format; translating extracted features into standardized contextual parameters; providing a unified interface for context modifier layer integration; and/or supporting extensibility to additional sensor modalities and neural network architectures without requiring system architectural modification.

Furthermore, in some embodiments, alternatively or additionally, the analysis techniques may provide a context modifier layer. Notably, the analysis techniques may include or involve: receiving filtered environmental state from a sensor abstraction layer; retrieving current user context from a persistent user context store; fusing environmental state with user identity, preferences, goals, and/or relationship information; generating contextually modified query parameters that reflect combined environmental and user state; providing modified parameters to an adaptive knowledge store for contextually appropriate retrieval; and/or applying user context to retrieved information for output relevance ranking and presentation formatting.

In some embodiments, alternatively or additionally, the analysis techniques may provide a user context store for an environmental context system. Notably, the analysis techniques may include or involve: maintaining persistent storage of user identity and recognition parameters; storing stated and inferred user preferences; tracking current user goals and objectives; maintaining relationship mappings between user and one or more other entities in a knowledge store; recording historical interaction patterns for behavior learning; providing user context to a context modifier layer and an output contextualization layer; and/or receiving updates from a feedback loop incorporating new (not previously stored) information from one or more interactions.

Note that the analysis techniques may integrated one or more sensor inputs. Notably, the sensor integration may include or involve: input abstraction to provide a standardized interface for sensor data reception; feature encoding to provide a configurable feature extraction pipeline per type of sensor or sensor modality; entity matching to provide a similarity threshold configuration for entity resolution; and/or latency requirements to ensure real-time processing with a configurable maximum latency parameter.

Moreover, the analysis techniques may include one or more contradiction detection parameters. For example, the analysis techniques may include: a tolerance level, such as high, moderate and/or low sensitivity configurations; one or more comparison techniques, such as semantic similarity, logical consistency, numerical deviation, etc.; a resolution strategy, such as alert, escalate, request clarification, log, etc.; and/or provenance tracking, such as source, timestamp, and/or confidence level for stored information.

Furthermore, the analysis techniques may include a context switching configuration. Notably, the context switching configuration may include: one or more geographic parameters, such as a radius threshold, a location type classification, etc.; one or more temporal parameters, such as a time-of-day range, calendar integration, temporal decay, etc.; one or more entity parameters, such as a relationship type weight, a presence duration threshold, etc.; and/or one or more situational parameters, such as an activity classification model, environmental state encoding, etc.

Additionally, the analysis techniques may be assessed based at least in part on one or more performance characteristics. For example, the one or more performance characteristics may include: retrieval complexity, such as an O(log n) average case with environmental filtering; memory scaling, which may be linear with active environmental entity count; an update latency, which may be configurable based at least in part on an application requirement; and/or contradiction detection, such as an O(k), where k is a relevant comparison set size.

The environmental context integration extension to the dynamic AI context system may enable real-world awareness capabilities while maintaining the efficiency and scalability characteristics of the underlying adaptive context architecture. By treating environmental inputs (e.g., from an external sensor, such as facial recognition, geographic positioning, image recognition, audio processing, object detection, and/or another type of sensor) as contextual modifiers rather than architectural requirements, the dynamic AI context system may support diverse deployment scenarios from augmented reality wearables to autonomous navigation systems. For example, the sensor data may be used to dynamically modify what information gets retrieved from the knowledge store and how it gets presented to a user.

Moreover, the contradiction detection technique may provide information validation across domains, while the selective relevance filtering may ensure that environmental awareness does not compromise system responsiveness. Furthermore, the sensor abstraction layer may enable the use of emerging sensor technologies without requiring architectural modifications.

Thus, these embodiments may extend the dynamic AI context system from a text-and-data-focused knowledge management system into a comprehensive environmental awareness platform capable of supporting context-aware intelligent applications.

In some embodiments, environmental sensor data (from an arbitrary source) may flow through a sensor abstraction layer in an electronic device and/or a computer system that normalize different input types into a standardized format. This filtered environmental state may then be combined with stored user context (e.g., who the user is, what their goals are, their preference(s), their relationship(s) to another entity, etc.) to generate query parameters (or an input vector) for a knowledge store (such as a pretrained neural network).

The user's existing context may modify how environmental data affects the electronic device and/or the computer system. When the electronic device and/or the computer system detects a person's face, it may not just look up that person in isolation. Notably, it may look up that person in the context of the user's relationship to them, the user's current goals, and/or what would be relevant for this specific user to know. Thus, the same detected face may produce different retrieved information for different users based at least in part on their respective contexts.

The retrieved information may then pass through another contextualization operation before being output, where it may be re-ranked and formatted based at least in part on user context. In some embodiments, there may be a feedback loop in which new information from interactions may update the user context store and the main knowledge store.

These analysis techniques may include sensor abstraction. For example, a unified layer may accept output from an arbitrary type of sensor and may normalize it into a standardized format. This operation may make the analysis sensor-agnostic and extensible.

Moreover, user context integration may ensure that environmental inputs do not operate in isolation. They may be combined with stored user context (such as identity, preference(s), goal(s), relationship(s), historical pattern(s), etc.), e.g., before querying the knowledge store and before presenting results. Thus, the same environmental conditions may produce different, personalized results for different users.

Furthermore, the analysis may use entity recognition and automatic association. For example, when the analysis detects an entity (a person, an object, a location, etc.) through an arbitrary type of sensor, it may automatically match that entity against the knowledge store and may retrieve relationship-aware information modified by the user context.

Additionally, the analysis may use contradiction detection. This may allow the analysis to identify conflicting information across multiple dimensions, such as: temporal contradictions (e.g., statements made at different times that conflict with each other); multi-sensor contradictions (such as different sensors reporting conflicting data about the same thing, e.g., when a camera does not detect an obstacle but radar does detect one); and/or cross-referential contradictions (which may detect that new information conflicts with stored knowledge).

Note that the tolerance level may be configurable based at least in part on application domain. Safety-critical systems may flag matches and conversational systems may use semantic thresholds.

In some embodiments, the analysis may use environmental context switching. Notably, the analysis may automatically adjust retrieval parameters based at least in part on environmental context without explicit user commands. Location, time, a detected entity, and/or an inferred situation may modify how the knowledge store (such as the pretrained neural network) is traversed. This may work through category switching, relevance weight adjustment, and/or distance-based filtering.

Moreover, the analysis may use continuous context streaming. Notably, the analysis may support event-driven updates (e.g., detection of a new face may trigger a query or input vector), periodic polling, and/or hybrid approaches. This efficiency may be maintained through differential processing and selective activation.

Furthermore, the analysis may use selective relevance filtering. Notably, the analysis may use environmental context constraints on what gets retrieved, thereby ensuring that the performance remains constant regardless of the total dataset size. Thus, the analysis may access a subset of data that is relevant to current environmental and user context.

The analysis may be used for a variety of applications. These applications may use adaptive context management to create environmentally-aware, personalized, and/or contradiction-detecting knowledge retrieval. For example, in an augmented reality/wearable system, a user may: wear glasses that identify people in view, retrieve relevant information about each person based at least in part on the user's relationship to them and current goals (e.g., a networking event, a sales meeting, a social gathering, etc.), flag contradictions in conversation against stored information, and/or save notes back to the knowledge store.

Moreover, in autonomous navigation, multiple sensors may feed the analysis, contradiction detection may identify when sensors disagree (e.g., an image sensor versus radar), the analysis may integrate one or more additional data sources to resolve conflicts, and/or geographic context may limit knowledge retrieval to relevant local information (e.g., the retrieved information may be restricted to or associated with a location in an environment of a user).

Furthermore, in sales/professional workflows, the analysis may: recognize meeting participants, retrieve a relationship history and relevant information based at least in part on a professional context, monitor a conversation for contradictions against known facts, and/or automatically log new information for future reference.

Additionally, in location-based assistance, a geographic position may trigger context switch to location-relevant categories, user preferences filter results (restaurant recommendations based on dietary preferences, price range, historical patterns, etc.), and the results may update as a user moves.

We now describe exemplary embodiments of method 1600 (FIG. 16) for different pretrained neural network architectures and application domains. Examples 1 and 2 use LLMs (transformer architectures). Examples 3 and 4 use convolutional and recurrent neural networks respectively, demonstrating that the method is architecture-agnostic.

Example 1: Sales professional at a networking conference. Neural network type: LLM (transformer architecture). A sales professional wearing smart glasses may enter a conference hall. The system (e.g., the glasses and/or a computer system) may dynamically retrieve and present relevant information about the people and context around them without the user typing anything. In operation 1610 (receive information associated with an environment), the smart glasses (the electronic device) may capture the following environmental information and transmit it to the computer system: facial recognition data: a camera in the glasses may detect an individual standing nearby. The on-device neural network may process the image and encode the individual's facial features into a numerical representation (a face embedding vector); location data: a Global Positioning System (GPS) module may report that the user is at the Moscone Center in San Francisco; audio data: a microphone in the glasses may pick up ambient conversation indicating a keynote session on ‘enterprise AI adoption’ has just concluded; and/or proximity data: Bluetooth beacons may indicate that the user is in the main networking hall, approximately three meters from the detected individual.

Then, in operation 1612 (access a stored context), a computer system may receive, from the glasses, the facial recognition embedding and may query a stored context in a graph database. The computer system may match the face embedding against known entity records and may retrieve the following stored context: entity match: ‘Sarah Chen, Vice President of Engineering at Meridian Health Systems’; relationship data: Sarah's company (Meridian Health) may be a current prospect in the user's sales pipeline. The user's colleague may have had a demonstration call with Meridian two weeks ago; user context: the user may have an active goal of closing three enterprise healthcare deals this quarter. Their preference profile may indicate that they favor technical talking points over pricing discussions in early-stage conversations; and/or historical data: the user may have met Sarah briefly at a different event six months ago. They may have discussed interoperability challenges in electronic health records.

Next, in operation 1614 (determine a dynamic content window), the computer system may determine a dynamic content window (DCW) based at least in part on the environmental information and the stored context. The pretrained neural network may have a maximum context capacity of 128,000 tokens, but the computer system may determine that a dynamic content window of 1,200 tokens is appropriate for this interaction (far less than the maximum). This length may be chosen because: the user needs a concise, at-a-glance briefing for a fast-paced networking environment; only the most relevant entity and relationship data should be surfaced; and/or smaller content windows produce faster, more focused responses.

Moreover, in operation 1616 (generate an input vector), the computer system may construct an input vector (a structured prompt) that combines the environmental information, the retrieved context, and/or the dynamic content window constraint. The prompt may include: who was recognized, the relationship status, prior interaction history, the user's goals, and/or a request for a concise briefing with a suggested conversation opener. This input vector may be sized to fit within the 1,200-token dynamic content window.

Furthermore, in operation 1618), provide the input vector and the dynamic content window to the pretrained neural network. The computer system may send the input vector and the dynamic content window to a pretrained neural network, e.g., a large language model based at least in part on a transformer architecture. The dynamic content window may constrain both the input context and the expected output length.

Additionally, in operation 1620 (receive a response vector), the pretrained neural network may process the input vector within the dynamic content window and may return a response vector. For example, the response vector may be: Sarah Chen—Vice President Engineering, Meridian Health. Active prospect (demonstration completed two weeks ago by your colleague). You met at Health Technology Summit and discussed electronic health record interoperability pain points. Suggested opener: Sarah, good to see you again. My team followed up on those interoperability challenges you mentioned. I'd love to hear how that's evolved at Meridian.

Then, in operation 1622 (provide the response vector), the computer system may transmit the response vector back to the smart glasses (the electronic device). The smart glasses may display the briefing on the heads-up display in the glasses before the user initiates a conversation with Sarah.

Next, in operation 1624 (perform one or more additional operations), after the interaction, the system may optionally perform additional operations. For example, the system may update the context: the graph database may be updated to record this encounter (date, location, conversation topic, etc.). Alternatively or additionally, the system may modify the dynamic content window: the system may increase the dynamic content window for follow-up queries to 2,500 tokens, thereby enabling deeper technical detail when the user asks a follow-up question during the conversation. In some embodiments, the system may perform contradiction detection: when the stored pipeline status (‘active prospect’) conflicts with newer information (e.g., Meridian chose a competitor), the system may flag this contradiction.

Example 2: Field service technician at a power substation. Neural network type: LLM (Transformer Architecture). A field technician wearing a hardhat-mounted camera may arrive at a power substation to perform maintenance. The system (such as the camera and/or a computer system) may use visual recognition, information associated with the Global Positioning System, and/or environmental data to identify equipment and may provide context-aware repair guidance without the technician typing a query.

Notably, in operation 1610 (receive information associated with an environment), the technician's wearable camera and sensors (the electronic device) may capture environmental information and may transmit it to the computer system. For example, the captured environmental information may include: image recognition data: the camera may capture an image of a large transformer unit. An on-device convolutional neural network may identify the equipment as a ‘General Electric Prolec 50 MVA Power Transformer’ based at least in part on visual features; location data: Global Positioning System reports the technician is at Substation 14-B (37.4419° N, 122.1430° W), a utility facility in Palo Alto, California; object detection data: the camera may detect a visible oil stain beneath the transformer and a discolored section on the cooling fins; and/or audio data: a microphone associated with the camera may detect an unusual low-frequency humming that differs from normal operating sounds.

Then in operation 1612 (access a stored context), a computer system may receive the equipment identification and location data, and may query the stored context in a graph database: entity match: General Electric Prolec 50 MVA Transformer, Unit ID: SUB14B-T3, installed 2018, last serviced March 2025; maintenance history: three prior service records, including a dissolved gas analysis (June 2024) showing slightly elevated acetylene levels (an early indicator of thermal faults); related entities: the transformer feeds distribution circuit 7742, serving 4,200 residential customers; user context: the technician is a Level 3 certified transformer specialist who prefers step-by-step procedural guidance with safety warnings first; and/or environmental history: ambient temperature has been 15 F above seasonal norms for the past two weeks.

Next, in operation 1614 (determine a dynamic content window), the computer system may determine a dynamic content window of 2,200 tokens. This is larger than in example 1 because: safety-critical field procedures may require more detail; the technician may need specific diagnostic steps; and/or the context may include relevant maintenance history that informs the diagnosis.

Moreover, in operation 1616 (generate an input vector), the computer system may construct an input vector combining: the equipment identification, observed symptoms (oil stain, discolored fins, abnormal hum, etc.), relevant maintenance history (elevated acetylene), environmental conditions (above-normal temperatures), and/or the technician's certification level and formatting preferences.

Furthermore, in operation 1618 (provide the input vector and the dynamic content window to the pretrained neural network), the computer system may send the input vector and the 2,200-token dynamic content window to the pretrained neural network, such as an LLM based at least in part on a transformer architecture.

Additionally, in operation 1620 (receive a response vector), the neural network may return a response vector containing: a safety warning: maintain minimum approach distance (10 ft) because a potential thermal fault may be in progress; an assessment: symptoms combined with elevated acetylene are consistent with a developing thermal fault in winding insulation, possibly accelerated by above-normal ambient temperatures; immediate actions: photograph visible damage, take infrared thermal scan looking for hotspots above 105 C, and/or collect oil sample for expedited dissolved gas analysis; and/or escalation: if thermal scan confirms hotspot greater than 105 C, initiate load transfer per procedure SUB-EMG-003 and notify dispatch that Circuit 7742 (4,200 customers) may require a planned outage.

Then, in operation 1622 (provide the response vector), the computer system may transmit the response vector to the technician's wrist-mounted display.

In some embodiments, in operation 1624 (perform one or More additional operations), the system may optionally perform additional operations. For example, the system may update the context: the graph database may be updated with a new service event (date, symptoms, technician identity, etc.). Alternatively or additionally, the system may modify the dynamic content window: for follow-up questions, the system may increase the window to 3,500 tokens to include the full emergency load-transfer procedure. In some embodiments, the system may perform contradiction detection: if the thermal scan shows normal temperature (contradicting visual/audio symptoms), the system may flag this discrepancy. Note that the system may perform a knowledge store update: the correlation between observed symptoms and the thermal fault diagnosis may be stored as a pattern for future retrievals.

Example 3: Autonomous vehicle in a construction zone. Neural network type: convolutional neural network (CNN with residual and dense layers). An autonomous vehicle may approach a road segment where construction has altered the normal traffic pattern. The system (such as the autonomous vehicle and/or a computer system) may use one or more convolutional neural networks for visual perception, combined with stored road context, to make real-time navigation decisions. An LLM may not be involved. Instead, the pretrained neural network may be a multi-layer convolutional neural network optimized for scene understanding and path planning.

Notably, in operation 1610 (receive information associated with an environment), the vehicle's sensor array (the electronic device) may capture environmental information and may transmit it to the computer system. The captured environmental information may include: image data: forward-facing cameras may capture images of the road ahead. An on-board convolutional neural network may detect: orange traffic cones narrowing the road from three lanes to one, a flagging worker holding a ‘SLOW’ sign, and/or a line of stopped vehicles; LIDAR data: a LIDAR sensor in the vehicle may generate a three-dimensional point cloud revealing that the right two lanes are blocked by construction barriers extending approximately 200 meters, with a temporary lane shift to the left; location data: Global Positioning System and inertial measurement may report the vehicle is on Highway 101 northbound at mile marker 412.3, traveling at 45 mph; and/or object detection data: the perception convolutional neural network may identify a construction excavator operating approximately 80 meters ahead, partially within the temporary lane boundary.

Then, in operation 1612 (access a stored context), the computer system may receive the environmental data and may query the stored context: road context: Highway 101 northbound at mile marker 412.3 may have an active construction permit (February-April 2026). The stored context may include the permitted zone boundaries, approved temporary traffic pattern (single-lane alternating flow), and/or posted speed limit reduction (25 mph); historical traffic data: this zone may have experienced an average four-minute delay during peak hours. Two minor rear-end collisions may have been recorded involving vehicles that failed to reduce speed in time; and/or vehicle context: the vehicle may be carrying two passengers with a destination of San Francisco International Airport (a flight at 5:15 PM).

Next, in operation 1614 (determine a dynamic content window), the computer system may determine a dynamic content window equivalent to 4,800 parameters, which is compact enough for the convolutional neural network to process within the approximately two-second decision window available at 45 mph. The dynamic content window may encode only the relevant road geometry, obstacle positions, speed constraints, and/or the flagging worker's instruction. Note that extraneous context (permit dates, historical delay statistics, and/or passenger flight information) may be excluded because it does not affect the immediate navigation decision.

Moreover, in operation 1616 (generate an input vector), the computer system may generate an input vector (such as a structured tensor that combines sensor data with retrieved context). For example, the input vector may include: sensor tensor: camera and LIDAR data may be fused into a bird's-eye-view occupancy grid showing lane boundaries (including the temporary single-lane shift), cone positions, the flagging worker, stopped vehicles, and/or the excavator's position and movement trajectory; context overlay: the posted speed limit (25 mph) may be encoded as a scalar, the approved lane configuration may be encoded as a lane mask, and/or the SLOW instruction may be encoded as a velocity constraint; and/or vehicle state: a current speed (45 mph), heading, and/or braking distance may be appended.

Furthermore, in operation 1618 (provide the input vector and the dynamic content window to the pretrained neural network), the computer system may provide the input vector and the dynamic content window to a multi-layer convolutional neural network with residual connections, trained for autonomous driving path planning. The convolutional neural network may include convolutional layers for spatial feature extraction, residual layers for gradient flow, and dense layers for trajectory output. The dynamic content window may constrain the input to only the relevant spatial region and contextual parameters.

Additionally, in operation 1620 (receive a response vector), the convolutional neural network may process the input vector and may return a response vector (such as a planned trajectory): waypoint 1: begin deceleration from 45 mph to 25 mph over the next 80 meters (smooth braking profile); waypoint 2: merge left into the temporary single lane at mile marker 412.15 (lateral shift of 3.5 meters over 40 meters); waypoint 3: maintain 25 mph in the single lane, following the vehicle ahead at a three-second gap; and/or waypoint 4: pass the excavator on the left with a minimum clearance of 2.0 meters. Note that a confidence score may be 0.94.

Then, in operation 1622 (provide the response vector), the computer system may send the response vector (the planned trajectory) to the vehicle's drive-by-wire system (in the electronic device), which executes the braking and steering commands.

In some embodiments, in operation 1624 (perform one or more additional operations), the system optionally performs additional operations. For example, the system may update the context: the graph database may be updated with the current construction zone state (single-lane active, excavator position, flagging worker present, etc.). This updated context may be available to other vehicles querying the same road segment. Alternatively or additionally, the system may modify the dynamic content window: as the vehicle approaches the excavator, the system may increase the window to 7,200 parameters to include the excavator's movement trajectory prediction for detailed avoidance planning. In some embodiments, the system may perform contradiction detection: If stored context indicates two lanes should be open but sensors detect only one, the system may default to real-time sensor data and log the map discrepancy for correction.

Example 4: Medical wearable detecting a cardiac anomaly. Neural network type: a recurrent neural network (such as a bi-directional long short-term memory or LSTM with softmax). A patient wearing a medical-grade smartwatch may experience an irregular heart rhythm during normal daily activity. The system (such as the wearable and/or a computer system) may use a recurrent neural network (specifically a long short-term memory network) trained on physiological time-series data to classify the anomaly. An LLM may not be involved. Instead, the pretrained neural network may be a recurrent neural network specialized for sequential biomedical signal analysis.

Notably, in operation 1610 (receive information associated with an environment), a smartwatch (the electronic device) may capture continuous physiological and environmental data and may transmit it to the computer system when an anomaly is detected. The physiological and environmental data may include photoplethysmography (PPG) data: the optical heart rate sensor may record a thirty-second waveform showing irregular inter-beat intervals. Three consecutive beats may deviate from baseline by more than two standard deviations, triggering an anomaly flag; accelerometer data: a three-axis accelerometer may confirm that the patient is seated (low movement amplitude), ruling out motion artifacts; location data: a Global Positioning System may indicate that the patient is at their home address (not at a gym or in a vehicle); and/or ambient data: a barometric-pressure sensor may report normal pressure (1013 hPa) and a temperature sensor may read 72 F, ruling out altitude or extreme temperature as contributing factors.

Then, in operation 1612 (access a stored context), the computer system may receive the anomaly data and may query the stored context in a graph database: patient record: 62-year-old male with a history of hypertension (controlled) and a family history of atrial fibrillation. There may not be a prior diagnosed arrhythmia(s); medication context: current medications may include lisinopril 10 mg (an ACE inhibitor) and a low-dose aspirin. There may not be any recent changes. The graph database may link lisinopril to a known interaction profile (it does not typically cause arrhythmia); baseline physiology: over the past 90 days, resting heart rate has averaged 68 bpm (±4 bpm). Heart rate variability within normal range. No prior anomaly flags; and/or recent context: the patient may report feeling ‘slightly dizzy’ to a telehealth chatbot three days ago. The graph database may link this report to the current event as potentially related.

Next, in operation 1614 (determine a dynamic content window), the computer system may determine a dynamic content window of 3,600 time steps (encoding the thirty-second PPG waveform at 120 Hz or 3,600 samples) with eight contextual feature channels (baseline heart-rate mean, baseline heart-rate standard deviation, age, sex, atrial fibrillation family history flag, medication class, activity level, and/or the recent dizziness symptom flag). The maximum input capacity of the recurrent neural network may be 10,000 time steps, but the dynamic content window may be sized to include only the anomalous segment with the most clinically relevant context. Note that extraneous data (full 90-day waveform history, atmospheric details, insurance information, etc.) may be excluded.

Moreover in operation 1616 (generate an input vector), the computer system may generate an input vector (such as a structured time-series tensor): primary signal: the thirty-second PPG waveform sampled at 120 Hz (3,600 samples), normalized against the patient's 90-day baseline (zero-mean, unit-variance); and/or context channels: eight feature channels appended to each time step: mean resting heart rate (68 bpm), heart-rate standard deviation (four bpm), age (62), biological sex (male=1), family atrial fibrillation history (positive=1), medication class (ACE inhibitor=2), activity level (resting=0), and/or recent symptom flag (dizziness within 72 hours=1). Note that the resulting tensor shape may be [3,600×9] or 3,600 time steps with nine channels.

Furthermore, in operation 1618 (provide the input vector and the dynamic content window to the pretrained neural network), the computer system may provide the input vector and the dynamic content window to a bi-directional LSTM with two recurrent layers and a dense classification head, trained on 500,000 annotated electrocardiogram/PPG segments. Note that the pretrained neural network may include LSTM layers for capturing temporal dependencies, dropout layers for regularization, and/or a dense output layer with a softmax activation function producing probability scores across five arrhythmia categories.

Additionally, in operation 1620 (receive a response vector), the LSTM may processes the input sequence and may return a response vector, such as a classification with probability scores: atrial fibrillation (AF): 0.78 probability; premature atrial contractions (PAC): 0.14 probability; normal sinus arrhythmia: 0.05 probability; premature ventricular contractions (PVC): 0.02 probability; and/or ventricular tachycardia: 0.01 probability. Note that the response vector may include flagged contributing factors: family history of atrial fibrillation (positive), recent dizziness symptom (correlated), and/or resting state (rules out exercise-induced arrhythmia).

Then, in operation 1622 (provide the response vector), the computer system may transmit the response vector to the smartwatch (the electronic device). The watch may alert the patient with a gentle vibration and may display: ‘Irregular heart rhythm detected. Pattern consistent with atrial fibrillation. Confidence: high. Recommendation: Contact your physician within 24 hours. If you experience chest pain, shortness of breath, or fainting, call 911.’ Simultaneously, a detailed clinical summary may be sent to the patient's designated physician via a secure health application programming interface.

In some embodiments, in operation 1624 (perform one or more additional operations), the system optionally performs additional operations. For example, the system may update the context: the graph database may record the anomaly event (timestamp, classification, activity state, location, etc.). A new relationship edge may link this event to the dizziness report from three days ago. Alternatively or additionally, the system may modify the dynamic content window: the system may shift to heightened surveillance, e.g., increasing the content window to 7,200 time steps (60-second segments) and reducing the analysis interval to every 60 seconds for the next 24 hours. In some embodiments, the system may perform contradiction detection: if a new anti-arrhythmic medication appears in the patient's record without a corresponding physician visit or diagnosis, the system may flag this discrepancy. Note that the system may perform a knowledge store update: the confirmed atrial fibrillation detection, combined with patient demographics (age 62, atrial fibrillation family history, recent dizziness, hypertension, etc.), may be stored as a case pattern for earlier screening of similar profiles.

While the preceding four examples illustrated method 1600 (FIG. 16) with an electronic device and a separate computer system, in other embodiments some or all of the operations may be performed by either or both of the electronic device and the computer system. For example, in some embodiments, the computer system may be integrated into the electronic device. This may allow the analysis techniques to be performed even when a communication link to an external computer system is unavailable. Notably, in some embodiments, the electronic device and the computer system may be combined or integrated into a drone, such as: an aerial drone, a ground-based drone, a sea-based drone, or a subterranean drone. Then, even when interference or communication obstacles (such as an undersea drone) prevent communication with an external computer system, the drone may be able to perform the operations in method 1600 (FIG. 16). Moreover, the analysis techniques may provide significant performance improvements in such as resource-constrained environment, including: reduced power consumption, reduced memory consumption, reduced network bandwidth, faster response or processing times for prompts, etc.

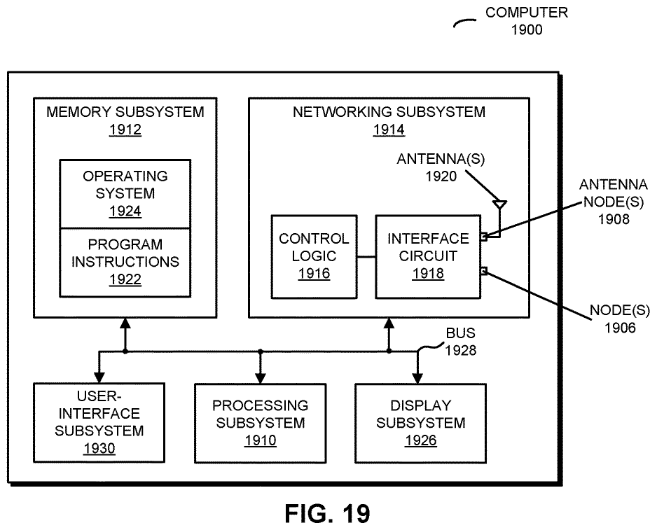

We now describe embodiments of a computer, which may perform at least some of the operations in the analysis techniques. FIG. 19 presents a block diagram illustrating an example of a computer 1900, e.g., in a computer system (such as computer system 100 in FIG. 1), in accordance with some embodiments. For example, computer 1900 may include: one of computers 110. This computer may include processing subsystem 1910, memory subsystem 1912, and networking subsystem 1914. Processing subsystem 1910 includes one or more devices configured to perform computational operations. For example, processing subsystem 1910 can include one or more microprocessors, ASICs, microcontrollers, programmable-logic devices, GPUs and/or one or more DSPs. Note that a given component in processing subsystem 1910 are sometimes referred to as a ‘computation device’.

Memory subsystem 1912 includes one or more devices for storing data and/or instructions for processing subsystem 1910 and networking subsystem 1914. For example, memory subsystem 1912 can include dynamic random access memory (DRAM), static random access memory (SRAM), and/or other types of memory. In some embodiments, instructions for processing subsystem 1910 in memory subsystem 1912 include: program instructions or sets of instructions (such as program instructions 1922 or operating system 1924), which may be executed by processing subsystem 1910. Note that the one or more computer programs or program instructions may constitute a computer-program mechanism. Moreover, instructions in the various program instructions in memory subsystem 1912 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1910.

In addition, memory subsystem 1912 can include mechanisms for controlling access to the memory. In some embodiments, memory subsystem 1912 includes a memory hierarchy that comprises one or more caches coupled to a memory in computer 1900. In some of these embodiments, one or more of the caches is located in processing subsystem 1910.

In some embodiments, memory subsystem 1912 is coupled to one or more high-capacity mass-storage devices (not shown). For example, memory subsystem 1912 can be coupled to a magnetic or optical drive, a solid-state drive, or another type of mass-storage device. In these embodiments, memory subsystem 1912 can be used by computer 1900 as fast-access storage for often-used data, while the mass-storage device is used to store less frequently used data.

Networking subsystem 1914 includes one or more devices configured to couple to and communicate on a wired and/or wireless network (i.e., to perform network operations), including: control logic 1916, an interface circuit 1918 and one or more antennas 1920 (or antenna elements). (While FIG. 19 includes one or more antennas 1920, in some embodiments computer 1900 includes one or more nodes, such as antenna nodes 1908, e.g., a metal pad or a connector, which can be coupled to the one or more antennas 1920, or nodes 1906, which can be coupled to a wired or optical connection or link. Thus, computer 1900 may or may not include the one or more antennas 1920. Note that the one or more nodes 1906 and/or antenna nodes 1908 may constitute input(s) to and/or output(s) from computer 1900.) For example, networking subsystem 1914 can include a BluetoothTM networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, and/or another networking system.

Networking subsystem 1914 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, computer 1900 may use the mechanisms in networking subsystem 1914 for performing simple wireless communication between electronic devices, e.g., transmitting advertising or beacon frames and/or scanning for advertising frames transmitted by other electronic devices.

Within computer 1900, processing subsystem 1910, memory subsystem 1912, and networking subsystem 1914 are coupled together using bus 1928. Bus 1928 may include an electrical, optical, and/or electro-optical connection that the subsystems can use to communicate commands and data among one another. Although only one bus 1928 is shown for clarity, different embodiments can include a different number or configuration of electrical, optical, and/or electro-optical connections among the subsystems.

In some embodiments, computer 1900 includes a display subsystem 1926 for displaying information on a display, which may include a display driver and the display, such as a liquid-crystal display, a multi-touch touchscreen, etc. Moreover, computer 1900 may include a user-interface subsystem 1930, such as: a mouse, a keyboard, a trackpad, a stylus, a voice-recognition interface, and/or another human-machine interface.

Computer 1900 can be (or can be included in) any electronic device with at least one network interface. For example, computer 1900 can be (or can be included in): a desktop computer, a laptop computer, a subnotebook/netbook, a server, a supercomputer, a tablet computer, a smartphone, a cellular telephone, a consumer-electronic device, a portable computing device, communication equipment, and/or another electronic device.

Although specific components are used to describe computer 1900, in alternative embodiments, different components and/or subsystems may be present in computer 1900. For example, computer 1900 may include one or more additional processing subsystems, memory subsystems, networking subsystems, and/or display subsystems. Additionally, one or more of the subsystems may not be present in computer 1900. Moreover, in some embodiments, computer 1900 may include one or more additional subsystems that are not shown in FIG. 19. Also, although separate subsystems are shown in FIG. 19, in some embodiments some or all of a given subsystem or component can be integrated into one or more of the other subsystems or component(s) in computer 1900. For example, in some embodiments program instructions 1922 are included in operating system 1924 and/or control logic 1916 is included in interface circuit 1918.

Moreover, the circuits and components in computer 1900 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 1914 and/or computer 1900. The integrated circuit may include hardware and/or software mechanisms that are used for transmitting signals from computer 1900 and receiving signals at computer 1900 from other electronic devices. Aside from the mechanisms herein described, radios are generally known in the art and hence are not described in detail. In general, networking subsystem 1914 and/or the integrated circuit may include one or more radios.

In some embodiments, an output of a process for designing the integrated circuit, or a portion of the integrated circuit, which includes one or more of the circuits described herein may be a computer-readable medium such as, for example, a magnetic tape or an optical or magnetic disk or solid state disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the analysis techniques may be implemented using program instructions 1922, operating system 1924 (such as a driver for interface circuit 1918) or in firmware in interface circuit 1918. Thus, the analysis techniques may be implemented at runtime of program instructions 1922. Alternatively or additionally, at least some of the operations in the analysis techniques may be implemented in a physical layer, such as hardware in interface circuit 1918.

In the preceding description, we refer to ‘some embodiments’. Note that ‘some embodiments’ describes a subset of all of the possible embodiments, but does not always specify the same subset of embodiments. Moreover, note that the numerical values provided are intended as illustrations of the analysis techniques. In other embodiments, the numerical values can be modified or changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
an interface circuit configured to communicate with an electronic device;
a computation device coupled to the interface circuit;
memory, coupled to the computation device, storing program instructions, wherein, when executed by the computation device, the program instructions cause the computer system to perform one or more operations comprising:
receiving, from the electronic device, information associated with an environment of the electronic device;
accessing a stored context corresponding to the information;
determining a dynamic content window based at least in part on the information, the context, or both, wherein the dynamic content window has a length less than a predefined value;
generating an input vector based at least in part on the information, the context and the dynamic content window;
providing, to a pretrained neural network, the input vector and the dynamic content window;
receiving, from the pretrained neural network, a response vector; and
providing, addressed to the electronic device, the response vector.

2. The computer system of claim 1, wherein the operations comprise modifying the dynamic content window based at least in part on the response vector.

3. The computer system of claim 1, wherein the context is stored in a graph database or data structure.

4. The computer system of claim 3, wherein the graph database or data structure comprises a vector graph database.

5. The computer system of claim 1, wherein the pretrained neural network comprises a large language model (LLM).

6. The computer system of claim 1, wherein the operations comprise updating the context based at least in part on the information, the input vector and/or the response vector.

7. The computer system of claim 1, wherein the predefined value is less than or equal to 8,095 tokens.

8. The computer system of claim 1, wherein the predefined value is significantly smaller than 128,000 tokens.

9. The computer system of claim 1, wherein the dynamic content window corresponds to a next operation in an interaction between the electronic device and the pretrained neural network.

10. The computer system of claim 1, wherein the pretrained neural network is implemented using or hosted by a second computer system, and
wherein the second computer system is different from the computer system.

11. The computer system of claim 1, wherein the response vector is based at least in part on the input vector and the dynamic content window.

12. The computer system of claim 1, wherein the pretrained neural network comprises one or more convolutional layers, one or more residual layers and one or more dense layers; and
wherein a given node in a given layer in the pretrained neural network comprises an activation function that comprises one or more of: a rectified linear activation function (ReLU), a leaky ReLU, an exponential linear unit (ELU) activation function, a parametric ReLU, a tanh activation function, or a sigmoid activation function.

13. The computer system of claim 1, wherein the information comprises: real-time data associated with the environment, facial recognition data, location data, image recognition data, audio, one or more images, object detection data, or another type of sensor data.

14. The computer system of claim 1, wherein, prior to accessing the context, the operations comprise normalizing the information.

15. A non-transitory computer-readable storage medium for use in conjunction with a computer system, the computer-readable storage medium storing program instructions that, when executed by the computer system, causes the computer system to perform one or more operations comprising:
receiving, from an electronic device, information associated with an environment of the electronic device;
accessing a stored context corresponding to the information;
determining a dynamic content window based at least in part on the information, the context, or both, wherein the dynamic content window has a length less than a predefined value;
generating an input vector based at least in part on the information, the context and the dynamic content window;
providing, to a pretrained neural network, the input vector and the dynamic content window;
receiving, from the pretrained neural network, a response vector; and
providing, addressed to the electronic device, the response vector.
The computer system of claim 1, wherein the operations comprise modifying the dynamic content window based at least in part on the response vector.

16. The non-transitory computer-readable storage medium of claim 15, wherein the operations comprise modifying the dynamic content window based at least in part on the response vector.

17. The non-transitory computer-readable storage medium of claim 15, wherein the information comprises: real-time data associated with the environment, facial recognition data, location data, image recognition data, audio, one or more images, object detection data, or another type of sensor data.

18. A method for determining a dynamic content window, comprising:
by a computer system:
receiving, from an electronic device, information associated with an environment of the electronic device;
accessing a stored context corresponding to the information;
determining the dynamic content window based at least in part on the information, the context, or both, wherein the dynamic content window has a length less than a predefined value;
generating an input vector based at least in part on the information, the context and the dynamic content window;
providing, to a pretrained neural network, the input vector and the dynamic content window;
receiving, from the pretrained neural network, a response vector; and
providing, addressed to the electronic device, the response vector.

19. The method of claim 18, wherein the method comprises modifying the dynamic content window based at least in part on the response vector.

20. The method of claim 18, wherein the information comprises: real-time data associated with the environment, facial recognition data, location data, image recognition data, audio, one or more images, object detection data, or another type of sensor data.
